(19) United States
(12) Patent Application Publication
(10) Pub. No.: US 2026/0234390 A1
(43) Pub. Date: Aug. 13, 2026

(54) RESIN COMPOSITION AND METHOD FOR PRODUCING SAME, AND MOLDED ARTICLE THEREFROM

(71) Applicant: Toray Plastics (Malaysia) Sdn. Berhad, Prai, Penang (MY)

(72) Inventors: Takuya Shibata, Prai,Penang (MY); Nur Ismah Binti Azali, Prai,Penang (MY); Muhammad Aziat Bin Hamzah, Prai,Penang (MY); Kah Aik Soon, Prai,Penang (MY)

(73) Assignee: Toray Plastics (Malaysia) Sdn. Berhad, Prai, Penang (MY)

(21) Appl. No.: 19/151,274

(22) PCT Filed: Apr. 19, 2024
(86) PCT No.: PCT/MY2024/050035

§ 371 Date: Jul. 25, 2025

(30) Foreign Application Priority Data
May 16, 2023 (MY) PI2023002915

(51) Int. Cl. C08L 51/04; C08F 265/04; C08F 279/04; C08K 5/17; C08K 5/521; C08L 25/12; C08L 51/06

(52) U.S. Cl. CPC C08L 51/04; C08F 265/04; C08F 279/04; C08K 5/17; C08K 5/521; C08L 25/12; C08L 51/06; C08L 2205/03; C08L 2205/035

(57) ABSTRACT

A resin composition includes a graft copolymer (A) obtained by graft copolymerization of a monomer mixture (a) including at least an aromatic vinyl monomer (a1) and a vinyl cyanide monomer (a2) in the presence of a rubber polymer (r); a vinyl copolymer (B) obtained by copolymerization of a monomer mixture (b) including at least an aromatic vinyl monomer (b1) and a vinyl cyanide monomer (b2); and either or both of a phosphate compound (E1) and a polyoxyethylene alkylamine (E2) in a specified amount(s).

### CROSS-REFERENCE TO RELATED APPLICATIONS

This application is a US national stage filing under 35 U.S.C. § 371 of International Application No. PCT/MY2024/050035, filed Apr. 19, 2024, which claims priority to Malaysian Patent Application No. PI2023002915, filed May 16, 2023, each of which is incorporated herein by reference in its entirety.

### TECHNICAL FIELD

This disclosure relates to resin compositions useful for resin molded articles that are used for home electric appliances, telecommunication devices, daily necessities, automobile components and the like.

### BACKGROUND

Rubber polymer-containing styrene-based thermoplastic resin compositions, represented by ABS (acrylonitrile-butadiene-styrene) resin, exhibit a good balance of mechanical strength properties, such as impact resistance and stiffness, and have excellent moldability. On the other hand, rubbery polymer-containing styrene-based thermoplastic resin compositions, represented by ASA (acrylonitrile-styrene-acrylate) resin, can provide excellent weather resistance, which is imparted by the ultraviolet stability of the acrylic rubber component, which is a saturated rubber. Any of the thermoplastic resins is widely used in application fields of home electric appliances, daily necessities, automobile components, and the like.

However, ABS resins have been prone to deterioration of appearance due to aggregation of a rubber polymer, and ASA resins have been prone to deterioration of appearance and reduction of coloration efficiency due to aggregation of a rubber polymer, which are problems associated with those resins.

The following method has been proposed as a method of improving the surface appearance (color tone, fish-eye formation) of a molded article. For example, JP H10-120740 A has proposed a method of producing rubber-modified thermoplastic resins, wherein monomer components comprising 6% to 63% by weight of an aromatic vinyl compound (b) and 2% to 49% by weight of a vinyl cyanide compound (c) are polymerized by using an alkyl mercaptopropionate having a specific structure as a molecular weight modifier in the presence of 30% to 80% by weight of a rubbery polymer (a) (provided that (a)+(b)+(c)=100% by weight). For example, JP 2005-232422 A has proposed a rubber-modified thermoplastic resin obtained by polymerization of a vinyl monomer (b) in the presence of a rubbery polymer (a), wherein the component (a) contained in the rubber-modified thermoplastic resin accounts for 40% to 80% by weight of the total of the component (a) and the component (b), and the component (b) comprises an aromatic vinyl compound (b1), a vinyl cyanide compound (b2), and a (meth)acrylate compound (b3), and the (meth)acrylate compound (b3) is a monomer from which a homopolymer with a glass transition temperature (Tg) of 0° C. or lower is made, and the component (b) accounts for 0.1% to 20% by weight of the whole resin composition.

On the other hand, styrene-based thermoplastic resin compositions that comprise a heat-resistant vinyl copolymer are widely used in application fields of automobile components, particularly for lamp housings, because molded articles made from such resin compositions have high heat resistance. Lamp housings normally undergo secondary processing, such as coating, metal vapor deposition, and plating, to enhance the brightness of vehicle lights. Each molded article is required to have a highly smooth surface before undergoing secondary processing, to provide a good appearance to the molded article after the secondary processing by coating, metal vapor deposition, plating, and the like. Normally, undercoating is applied to a molded article to smooth the surface of the molded article, which is then subjected to secondary processing. If a molded article naturally has a smooth surface, a metal layer can be formed directly on the smooth surface without need of forming an undercoat layer, which can reduce the cost of products. A so-called “direct deposition” method is known as a method of forming a metal layer without forming an undercoat layer, and the method is recently commonly used. Thus, resin compositions used for production of lamp housings and the like are required to provide excellent smoothness to molded articles.

The following methods have been proposed as methods of providing high impact resistance, high heat-resistance, good appearance for molded articles, and high vibration weldability to thermoplastic resin compositions used for lamp housings. For example, JP 2012-25941 A has proposed a thermoplastic resin composition for lamp housings, wherein the thermoplastic resin composition for lamp housings comprises (A) an acrylic rubber polymer-grafted resin obtained by polymerization of vinyl monomers comprising an aromatic vinyl compound and a vinyl cyanide compound in the presence of an acrylic rubber polymer (a1) having a gel fraction of not less than 70% by mass, having ability to swell 5.5 to 30 times in toluene, having a volume-average particle size of 100 nm to 200 nm, and providing a ratio of less than 1.1 between the volume-average particle size and the number-average particle size, (B) a composite rubber-grafted resin obtained by polymerization of vinyl monomers comprising an alkyl (meth)acrylate compound from which a homopolymer with a glass transition temperature of more than 0° C. is made, an aromatic vinyl compound, and a vinyl cyanide compound in the presence of a composite rubber (b1) comprising an organosiloxane rubber and a (co)polymer rubber having a structural unit derived from an alkyl (meth)acrylate, (C) a maleimide copolymer comprising a structural unit derived from a maleimide compound at 10% to 70% by mass relative to the above structural unit, and (D) a polymer comprising at least one structural unit selected from structural units derived from an aromatic vinyl compound, a vinyl cyanide compound, and an alkyl (meth)acrylate and not comprising a structural unit derived from a maleimide compound, wherein the total of the acrylic rubber polymer (a1) and the composite rubber (b1) accounts for 8% to 35% by mass relative to the total of the acrylic rubber-polymer graft resin (A), the composite rubber-grafted resin (B), the maleimide copolymer (C), and the polymer (D), which is taken as 100% by mass, and wherein the structural unit derived from a maleimide compound accounts for 5% to 30% by mass relative to the total of the structural unit that constitutes the acrylic rubber-polymer graft resin (A), the structural unit that constitutes the composite rubber-grafted resin (B), the structural unit that constitutes the maleimide copolymer (C), and the structural unit that constitutes the polymer (D), which is taken as 100% by mass. JP 2016-3284 A has proposed a thermoplastic resin composition comprising the following graft copolymer (A), graft copolymer (B), copolymer (C), and copolymer (D), wherein the mass ratio ((A):(B)) of the graft copolymer (A) to the graft copolymer (B) is 50:50 to 80:20, and the total content of rubbers derived from the graft copolymer (A) and from the graft copolymer (B) in the thermoplastic resin composition is 10% to 30% by mass, and the thermoplastic resin composition comprises a structural unit derived from a conjugated diene rubber at less than 2% by mass and the copolymer (C) at 10 parts to 30 parts by mass (provided that the total of the graft copolymer (A), the graft copolymer (B), the copolymer (C), and the copolymer (D) is taken as 100 parts by mass): Graft copolymer (A), an acrylic rubber graft copolymer obtained by graft polymerization of a monomeric component comprising at least one monomer selected from an aromatic vinyl monomer and a vinyl cyanide monomer on an acrylic rubber polymer (rs) obtained by polymerization of 0% to 20% by mass of a polyorganosiloxane and 80% to 100% by mass of an alkyl (meth)acrylate monomer (provided that the total of the polyorganosiloxane and the alkyl (meth)acrylate monomer is taken as 100% by mass) and has a volume-average particle size of 70 nm to 200 nm; Graft copolymer (B), an acrylic rubber graft copolymer obtained by graft polymerization of a monomeric component comprising at least one monomer selected from an aromatic vinyl monomer and a vinyl cyanide monomer on an acrylic rubber polymer (r1) obtained by polymerization of 0% to 30% by mass of a conjugated diene rubber polymer and 70% to 100% by mass of an alkyl (meth)acrylate monomer (provided that the total of the conjugated diene rubber polymer and the alkyl (meth)acrylate monomer is taken as 100% by mass) and has a volume-average particle size of 300 nm to 600 nm; Copolymer (C), a copolymer comprising maleimide monomeric units at 10% to 65% by mass relative to all the monomeric units that constitute the copolymer (C), which is taken as 100% by mass, and yielding a reduced viscosity of 0.4 dl/g to 0.7 dl/g at 25° C. when dissolved in N,N-dimethylformamide; Copolymer (D), a copolymer obtained by polymerization of a monomeric component comprising at least one monomer selected from an aromatic vinyl monomer and a vinyl cyanide monomer (provided that no maleimide monomer is contained) and yielding a reduced viscosity of 0.4 dl/g to 0.7 dl/g at 25° C. when dissolved in N,N-dimethylformamide.

Furthermore, the following method has been proposed as a method of providing emulsion polymer latex that provides excellent productivity during melt extrusion and from which molded resin products with a good appearance can be produced. For example, JP 2006-249198 A has proposed a method of producing emulsion polymer latex, wherein the method comprises the emulsion polymerization step for which an emulsifier comprising phosphoric acid at not more than 15000 ppm and a phosphate salt with a specific structure is used.

The following method has been proposed as a method of providing antistatic property, transparency, and suitability for aqueous ink printing to a polyolefin resin composition. For example, JP 2005-113104 A has proposed a polyolefin resin composition that comprises a polyoxyethylene alkylamine or polyoxyethylene alkenylamine having a specific structure at 0.05% to 2.00% by weight, wherein the polyolefin resin composition can be produced by adding X moles of ethylene oxide to 1 mole of an alkyl amine or alkenyl amine containing 8 to 22 carbon atoms, where X satisfies the formula: 2<X≤10.

However, any of the methods is insufficient to reduce deterioration of appearance (fish-eye formation, glossiness) due to aggregation of a rubber polymer and to improve coloration efficiency and, therefore, use of the methods in a wide range of applications was sometimes limited.

It could therefore be helpful to provide a resin composition that allows for use of impact resistance and high tensile elongation and reduces deterioration of appearance (fish-eye formation, glossiness) due to aggregation of a rubber polymer and provides a good coloration efficiency.

### SUMMARY

We found that, when either or both of a phosphate compound with a specific structure and a polyoxyethylene alkylamine with a specific structure in a specified amount(s) are added, a resin composition comprising a vinyl copolymer obtained by copolymerization of a vinyl monomer mixture and a rubber polymer-containing graft copolymer and optionally comprising a heat-resistant vinyl copolymer can reduce deterioration of appearance (fish-eye formation, glossiness) due to aggregation of a rubber polymer and also provide a good coloration efficiency.

Disclosed herein is:

(1) A resin composition including a graft copolymer (A) obtained by graft copolymerization of a monomer mixture (a) including at least an aromatic vinyl monomer (a1) and a vinyl cyanide monomer (a2) in the presence of a rubber polymer (r); a vinyl copolymer (B) obtained by copolymerization of a monomer mixture (b) including at least an aromatic vinyl monomer (b1) and a vinyl cyanide monomer (b2); and either or both of a phosphate compound (E1) represented by chemical formula (1) and a polyoxyethylene alkylamine (E2) represented by chemical formula (2), wherein the ratio of total amount of the phosphate compound (E1) and the polyoxyethylene alkylamine (E2) to the whole resin composition is not less than 60 ppm (mass/mass):

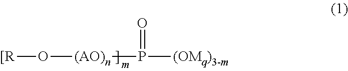

wherein R represents an alkyl or alkenyl group containing 8 to 22 carbon atoms; AO represents an oxyalkylene group containing 2 or 3 carbon atoms; n is an integer of 1 to 20; m is an integer of 1 or 2; M represents a hydrogen atom, a group I metal atom, or a group II metal atom; and q is 1 in cases where M is a hydrogen atom or a group I metal atom, or q is ½ in cases where M is a group II metal atom;

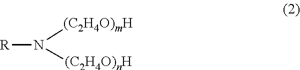

wherein R represents an alkyl or alkenyl group containing 8 to 22 carbon atoms; and m and n are positive integers that satisfy the formula: 2<m+n≤20.

(2) A method of producing a resin composition, the method including:
(A) producing an emulsion polymer latex obtained by graft copolymerization of a monomer mixture (a) including at least an aromatic vinyl monomer (a1) and a vinyl cyanide monomer (a2) in the presence of a rubber polymer (r), and adding either or both of a phosphate compound (E1) and a polyoxyethylene alkylamine (E2) to the emulsion polymer latex, and later allowing the emulsion polymer latex to contact aqueous sulfuric acid solution to produce a graft copolymer (A),
(B) producing a vinyl copolymer (B) obtained by copolymerization of a monomer mixture (b) including at least an aromatic vinyl monomer (b1) and a vinyl cyanide monomer (b2),
the optional step (C) of producing a heat-resistant vinyl copolymer (C) obtained by copolymerization of a vinyl monomer mixture (c) including at least an aromatic vinyl monomer (c1) and a maleimide monomer (c2), and
the step of mixing the graft copolymer (A), vinyl copolymer (B), and heat-resistant vinyl copolymer (C) obtained in the steps (A), (B), and (C) (provided that the heat-resistant vinyl copolymer (C) is an optional component),
wherein the ratio of total amount of the phosphate compound (E1) and the polyoxyethylene alkylamine (E2) to the whole resin composition is adjusted to be not less than 60 ppm (mass/mass).

We thus provide a resin composition that allows for use of impact resistance and high tensile elongation and reduces deterioration of appearance (fish-eye formation, glossiness) due to aggregation of a rubber polymer and also provides a good coloration efficiency.

### BRIEF DESCRIPTION OF THE DRAWINGS

FIG. 1 shows a transmission electron microscopy (TEM) image of a resin composition produced by a method described in Example 14.

FIG. 2 shows a transmission electron microscopy (TEM) image of a resin composition produced by a method described in Comparative Example 7.

### DETAILED DESCRIPTION

Our resin composition comprises at least the following components:
Component 1, a graft copolymer (A) obtained by graft copolymerization of a monomer mixture (a) comprising at least an aromatic vinyl monomer (a1) and a vinyl cyanide monomer (a2) in the presence of a rubber polymer (r);
Component 2, a vinyl copolymer (B) obtained by copolymerization of a monomer mixture (b) comprising at least an aromatic vinyl monomer (b1) and a vinyl cyanide monomer (b2);
Component 3, either or both of a phosphate compound (E1) represented by chemical formula (1) and a polyoxyethylene alkylamine (E2) represented by chemical formula (2):

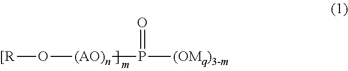

wherein R represents an alkyl or alkenyl group containing 8 to 22 carbon atoms; AO represents an oxyalkylene group containing 2 or 3 carbon atoms; n is an integer of 1 to 20; m is an integer of 1 or 2; M represents a hydrogen atom, a group I metal atom, or a group II metal atom; and q is 1 in cases where M is a hydrogen atom or a group I metal atom, or q is ½ in cases where M is a group II metal atom;

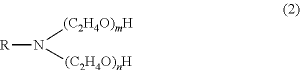

wherein R represents an alkyl or alkenyl group containing 8 to 22 carbon atoms, and m and n are positive integers that satisfy the formula: 2<m+n≤20.

Additionally, the resin composition is preferably allowed to comprise the following component;
Component 4, a heat-resistant vinyl copolymer (C) obtained by copolymerization of a vinyl monomer mixture (c) comprising at least an aromatic vinyl monomer (c1) and a maleimide monomer (c2).

Moreover, the resin composition may optionally comprise other components, as described below.

Although the effects of the components are not necessarily obvious, it is believed that the role of each component in the resin composition is as follows. That is, the graft copolymer (A) can increase the moldability of the resin composition and provide a molded article with reduced volatility and with higher impact resistance and tensile elongation. The vinyl copolymer (B) can increase the flowability of the resin composition and provide a molded article with an improved appearance and a higher coloration efficiency. The phosphate compound (E1) and the polyoxyethylene alkylamine (E2) can provide a molded article with an improved appearance, a higher coloration efficiency, and higher tensile elongation. Furthermore, the heat-resistant vinyl copolymer (C) can provide a molded article with heat resistance.

Each of the components will be described below in more detail.

### Component 1: Graft Copolymer (A)

The graft copolymer (A) is obtained by graft copolymerization of a monomer mixture (a) comprising at least an aromatic vinyl monomer (a1) and a vinyl cyanide monomer (a2) in the presence of a rubber polymer (r). The vinyl monomer mixture (a) may further comprise another monomer that can be copolymerized with the components (a1) and (a2) described below.

Examples of the rubber polymer (r) include polybutadiene, poly(butadiene-styrene) (SBR), poly(butyl acrylate) (acrylic rubber), poly(butadiene-butyl acrylate), poly(butadiene-methyl methacrylate), poly(butyl acrylate-methyl methacrylate), poly(butadiene-ethyl acrylate), and natural rubbers. Two or more of these materials may be used as the rubber polymer (r). Among those materials, polybutadiene, acrylic rubber, SBR, and natural rubbers are preferred, and polybutadiene and acrylic rubber are further preferred, as the rubber polymer (r) for further improving the impact resistance and the color tone.

Preferably, the content of the rubber polymer (r) is not less than 20% by mass and not more than 80% by mass relative to the total of the rubber polymer (r) and the vinyl monomer mixture (a), which are components of the graft copolymer (A). In cases where the content of the rubber polymer (r) is not less than 20% by mass, a molded article with higher impact resistance can be provided. It is more preferred that the content of the rubber polymer (r) be not less than 35% by mass. On the other hand, in cases where the content of the rubber polymer (r) is not more than 80% by mass, the finished resin composition can have higher flowability and a molded article with higher impact resistance, an improved appearance, and a higher coloration efficiency can be provided. It is more preferred that the content of the rubber polymer (r) be not more than 60% by mass.

The rubber polymer (r) preferably has a volume-average particle size of not less than 0.08 μm, more preferably not less than 0.10 μm, and is preferably not more than 0.40 μm, more preferably not more than 0.35 μm. In cases where the rubber polymer (r) has a volume-average particle size of not less than 0.08 μm, a molded article can be prevented from having lower impact resistance. In cases where the rubber polymer (r) has a volume-average particle size of not more than 0.40 μm, the finished resin composition can be prevented from having lower flowability and a molded article can be prevented from having a poorer appearance and a lower coloration efficiency.

Especially in the case of using polybutadiene as the rubber polymer (r), it is preferred that the polybutadiene have a volume-average particle size of not less than 0.2 μm and not more than 0.35 μm, considering that the range of volume-average particle size allows the rubber to be relatively well dispersed and also allows for production of a molded article with higher impact resistance without reducing the appearance and coloration efficiency of the molded article. Additionally, in the case of using acrylic rubber as the rubber polymer (r), it is preferred that the acrylic rubber have a volume-average particle size of not less than 0.08 μm and not more than 0.20 μm, to prevent a molded article from having lower impact resistance and to maintain the appearance and coloration efficiency of a molded article, because the rubber aggregates relatively easily.

The polybutadiene is known to be a synthetic rubber mainly composed of butadiene, and known polybutadiene rubbers can be used without any limitation. The acrylic rubber is known to be a synthetic rubber mainly composed of an acrylate ester, and known acrylic rubbers can be used without any limitation. For example, an acrylic rubber polymer described in known literature (JP 2016-176971 A) can be used.

Examples of the aromatic vinyl monomer (a1) in the vinyl monomer mixture (a) include styrene, α-methylstyrene, p-methylstyrene, m-methylstyrene, o-methylstyrene, vinyltoluene, and t-butylstyrene. Two or more of these monomers may be contained as the aromatic vinyl monomer (a1). Among those monomers, styrene is preferred as the aromatic vinyl monomer (a1) for providing a finished resin composition with higher flowability and a molded article with higher stiffness.

The content of the aromatic vinyl monomer (a1) in the vinyl monomer mixture (a) is preferably not less than 60% by mass, more preferably not less than 65% by mass, still more preferably not less than 70% by mass, relative to the total of the vinyl monomer mixture (a), which is taken as 100% by mass, for providing a finished resin composition with higher flowability and a molded article with higher stiffness. On the other hand, the content of the aromatic vinyl monomer (a1) in the vinyl monomer mixture (a) is preferably not more than 40% by mass, more preferably not more than 35% by mass, still more preferably not more than 30% by mass, for providing a molded article with higher impact resistance.

Examples of the vinyl cyanide monomer (a2) in the vinyl monomer mixture (a) include acrylonitrile, methacrylonitrile, and ethacrylonitrile. Two or more of these monomers may be contained as the vinyl cyanide monomer (a2). Among those monomers, acrylonitrile is preferred as the vinyl cyanide monomer (a2) from the viewpoint of providing a molded article with much higher impact resistance.

The content of the vinyl cyanide monomer (a2) in the vinyl monomer mixture (a) is preferably not less than 20% by mass, more preferably not less than 25% by mass, still more preferably not less than 30% by mass, relative to the total of the vinyl monomer mixture (a), which is taken as 100% by mass, from the viewpoint of providing a molded article with higher impact resistance. Moreover, the content of the vinyl cyanide monomer (a2) in the vinyl monomer mixture (a) is preferably not more than 40% by mass, more preferably not more than 35% by mass, still more preferably not more than 30% by mass, for providing a finished resin composition with higher flowability and a molded article with an improved color tone.

The above-mentioned another monomer that can be copolymerized with the aforementioned aromatic vinyl monomer (a1) and vinyl cyanide monomer (a2) is not specifically limited, provided that the above-mentioned another monomer is a vinyl monomer other than the vinyl monomer (a1) and the vinyl cyanide monomer (a2) and does not impair the desired effects. Specific examples of the above-mentioned another monomer include (meth)acrylate monomers (a3), unsaturated fatty acids, acrylamide monomers, and maleimide monomers. Two or more of these monomers may be contained as the above-mentioned another monomer.

As a (meth)acrylate monomer (a3) that can be contained in the vinyl monomer mixture (a), for example, an ester of an alcohol containing 1 to 6 carbon atoms and acrylic or methacrylic acid is preferred. The ester of an alcohol containing 1 to 6 carbon atoms and acrylic or methacrylic acid may further have a substituent such as hydroxy group or halogen group. Examples of the ester of an alcohol containing 1 to 6 carbon atoms and acrylic or methacrylic acid include methyl (meth)acrylate, ethyl (meth)acrylate, n-propyl (meth)acrylate, n-butyl (meth)acrylate, t-butyl (meth)acrylate, n-hexyl (meth)acrylate, cyclohexyl (meth)acrylate, chloromethyl (meth)acrylate, 3-hydroxypropyl (meth)acrylate, 2,3,4,5,6-pentahydroxyhexyl (meth)acrylate, and 2,3,4,5-tetrahydroxypentyl (meth)acrylate. Two or more of these monomers may be contained as the (meth)acrylate monomer (a2). Among those monomers, methyl (meth)acrylate is preferred as the (meth)acrylate monomer (a2) for providing a molded article with a higher coloration efficiency. The term “(meth)acrylate” refers to both acrylate and methacrylate; for example, methyl (meth)acrylate means both methyl methacrylate and methyl acrylate.

The content of the (meth)acrylate monomer (a3) in the vinyl monomer mixture (a) is preferably not less than 30% by mass, more preferably not less than 50% by mass, still more preferably not less than 70% by mass, relative to the total of the vinyl monomer mixture (a), which is taken as 100% by mass, for providing a molded article with a higher coloration efficiency. Moreover, the content of the (meth)acrylate monomer (a2) in the vinyl monomer mixture (a) is preferably not more than 90% by mass, more preferably not more than 85% by mass, still more preferably not more than 80% by mass, for providing a molded article with much higher impact resistance.

Examples of the unsaturated fatty acids include itaconic acid, maleic acid, fumaric acid, butenoic acid, acrylic acid, and methacrylic acid. Examples of the acrylamide monomers include acrylamide, methacrylamide, and N-methyl-acrylamide. Examples of the maleimide monomers include N-methylmaleimide, N-ethylmaleimide, N-isopropylmaleimide, N-butylmaleimide, N-hexylmaleimide, N-octylmaleimide, N-dodecylmaleimide, N-cyclohexylmaleimide, and N-phenylmaleimide.

The solvent-soluble fraction of the graft copolymer (A) is not limited to a specific weight-average molecular weight but preferably has a weight-average molecular weight of not less than 50,000 and more preferably a weight-average molecular weight of not less than 60,000. In cases where the solvent-soluble fraction of the graft copolymer (A) has a weight-average molecular weight of not less than 50,000, a molded article with higher impact resistance can be provided. Moreover, the solvent-soluble fraction of the graft copolymer (A) preferably has a weight-average molecular weight of not more than 120,000 and more preferably a weight-average molecular weight of not more than 100,000. In cases where the solvent-soluble fraction of the graft copolymer (A) has a weight-average molecular weight of not more than 120,000, the finished resin composition can have higher flowability.

In this respect, a solution of a solvent-soluble fraction at a concentration of about 0.2% by mass is produced by filtering a solvent-insoluble fraction from the graft copolymer (A) to obtain a filtrate, concentrating the filtrate on a rotary evaporator, and dissolving about 0.03 g of the resulting solvent-soluble fraction in about 15 g of tetrahydrofuran. The weight-average molecular weight of the solvent-soluble fraction of the graft copolymer (A) can be determined from a chromatogram of the above solution obtained by GPC measurement, relative to polystyrene as a standard (provided however, when (meth)acrylate monomer (a3) is used in the vinyl monomer mixture (a), polymethyl methacrylate is used as a standard). The GPC measurement can be performed under the following conditions. In this respect, the weight-average molecular weight of the solvent-soluble fraction is determined by using acetone as a solvent in cases where a polybutadiene rubber is used as the rubber polymer (r) or by using acetonitrile as a solvent in cases where an acrylic rubber is used as the rubber polymer (r). Especially, acetone is used as a solvent in cases where a butadiene-containing rubber polymer or a natural rubber is used, among those examples of the rubber polymer (r); acetonitrile is used as a solvent in cases where a rubber polymer mainly composed of an acrylate ester, like poly(butyl acrylate-methyl methacrylate), is used. Moreover, in cases where a rubber polymer other than those examples of the rubber polymer (r) is used, acetone is used as a solvent.
Measuring instrument: Waters 2695
Column temperature: 40° C.
Detector: RI2414 (differential refractometer)
Flow rate of carrier solution (eluate): 0.3 ml/min (solvent: tetrahydrofuran)
Column: TSKgel SuperHZM-M (6.0 mm I.D.×15 cm) and TSKgel SuperHZM-N (6.0 mm I.D.×15 cm) connected in series (both are manufactured by TOSOH Corporation)

The graft copolymer (A) is not limited to a specific grafting ratio, but the grafting ratio is preferred to be not less than 10% and not more than 100% and is more preferred to be not less than 30% and not more than 60% for providing a molded article with higher impact resistance, an improved appearance, and a higher coloration efficiency.

In this respect, the grafting ratio of the graft copolymer (A) can be determined by the following method. First, 80 ml of a solvent is added to about 1 g of the graft copolymer (A), and the resulting mixture is refluxed in a hot water bath at 70° C. for 3 hours. This solution is centrifuged at 8000 rpm (10,000 G) for 40 minutes, and an insoluble fraction is then filtered to obtain a solvent-insoluble fraction. The obtained solvent-insoluble fraction is dried at 80° C. under reduced pressure for 5 hours to measure the mass (the mass is represented by “n” in the formula below). The grafting ratio is calculated according to the formula below. In this formula, m represents the mass of the used sample of the graft copolymer (A), and X represents the content (% by mass) of a rubber polymer in the graft copolymer (A):

$$Grafting ratio ( \% ) = \{ [ ( n ) - ( ( m ) \times X / 100 ) ] / [ ( m ) \times X / 100 ] \} \times 100.$$

In this respect, the grafting ratio is determined by using acetone as a solvent in cases where a polybutadiene rubber is used as the rubber polymer (r) or by using acetonitrile as a solvent in cases where an acrylic rubber is used as the rubber polymer (r). Especially, acetone is used as a solvent in cases where a butadiene-containing rubber polymer or a natural rubber is used, among those examples of the rubber polymer (r); acetonitrile is used as a solvent in cases where a rubber polymer mainly composed of an acrylate ester, like poly(butyl acrylate-methyl methacrylate), is used. Moreover, in cases where a rubber polymer other than those examples of the rubber polymer (r) is used, acetone is used as a solvent.

The emulsion polymerization method is more preferred as a method of producing the graft copolymer (A) because the emulsion polymerization method can easily adjust the particle size of a rubber polymer (r) to a desired particle size range and easily control polymerization stability by removing heat during polymerization.

In cases where a graft copolymer (A) is produced by the emulsion polymerization method, charging of a rubber polymer (r) and a vinyl monomer mixture (a) is not limited to a specific method. For example, these components may be simultaneously charged in the initial stage, or a part of the vinyl monomer mixture (a) may be sequentially charged to adjust the distribution of the components of the copolymer, or a part or all of the vinyl monomer mixture (a) may be separately charged. In this respect, the phrase “a part of the vinyl monomer mixture (a) is sequentially charged” means that a part of the vinyl monomer mixture (a) is charged in the initial stage and the remaining part of the vinyl monomer mixture (a) is sequentially charged over time. Additionally, the phrase “the vinyl monomer mixture (a) is separately charged” means that the vinyl monomer mixture (a) is charged at a time point(s) later than the initial charging stage.

In the case of producing a graft copolymer (A) by the emulsion polymerization method, each type of surfactant may be added as an emulsifier. As the surfactant, an anionic surfactant, such as a carboxylate salt-type surfactant, a sulfate salt-type surfactant, or a sulfonate salt-type surfactant, is particularly preferred, and two or more of the anionic surfactants may be combined. Examples of the salt include alkali metal salts, such as sodium salts, lithium salts, and potassium salts, and ammonium salts.

Examples of the carboxylate salt-type emulsifier include caprylate salts, caprate salts, laurate salts, myristate salts, palmate salts, stearate salts, oleate salts, linoleate salts, linolenate salts, rosinate salts, behenate salts, and dialkyl sulfosuccinate salts.

Examples of the sulfate salt-type emulsifier include sulfate salts of castor oil, sulfate salts of lauryl alcohol, salts of polyoxyethylene lauryl sulfate, salts of polyoxyethylene alkyl ether sulfate, and salts of polyoxyethylene alkyl phenyl ether sulfate.

Examples of the sulfonate salt-type emulsifier include salts of dodecylbenzene sulfonate, salts of alkyl naphthalene sulfonate, salts of alkyl diphenyl ether disulfonate, and salts of condensed naphthalene sulfonate.

Among those emulsifiers, a carboxylate salt-type emulsifier is preferably added for providing a molded article with improved volatility.

In the case of producing a graft copolymer (A) by the emulsion polymerization method, an initiator may be added as needed. Examples of the initiator include peroxides, azo compounds, and water-soluble potassium persulfate, and two or more of the initiators may be combined. In addition, a redox polymerization initiator may be used as the initiator.

Examples of the peroxides include benzoyl peroxide, cumene hydroperoxide, dicumyl peroxide, diisopropylbenzene hydroperoxide, t-butyl hydroperoxide, t-butyl peroxyacetate, t-butyl peroxybenzoate, t-butylisopropyl carbonate, di-t-butyl peroxide, t-butyl peroxyoctate, 1,1-bis(t-butylperoxy)-3,3,5-trimethylcyclohexane, 1,1-bis(t-butylperoxy)cyclohexane, and t-butylperoxy-2-ethylhexanoate. Among peroxides, cumene hydroperoxide, 1,1-bis(t-butylperoxy)-3,3,5-trimethylcyclohexane, and 1,1-bis(t-butylperoxy)cyclohexane are especially preferable for use.

Examples of the azo compounds include azobis(isobutyronitrile), azobis(2,4-dimethylvaleronitrile), 2-phenylazo-2,4-dimethyl-4-methoxyvaleronitrile, 2-cyano-2-propyl-azoformamide, 1,1′-azobis(cyclohexane-1-carbonitrile), azobis(4-methoxy-2,4-dimethylvaleronitrile), dimethyl 2,2′-azobis(isobutyrate), 1-t-butylazo-2-cyanobutane, and 2-t-butylazo-2-cyano-4-methoxy-4-methylpentane. Among azo compounds, 1,1′-azobis(cyclohexane-1-carbonitrile) is especially preferable for use.

The added amount of the initiator used for the production of a graft copolymer (A) is not specifically limited, but it is preferred that the amount of the initiator be not less than 0.1 part by mass and not more than 0.5 part by mass relative to the total of the rubber polymer (r) and the vinyl monomer mixture (a), which is taken as 100 parts by mass, for easily adjusting the weight-average molecular weight of the solvent-soluble fraction of the graft copolymer (A) to the aforementioned weight-average molecular weight range.

In the case of producing a graft copolymer (A), a chain transfer agent may be used. The weight-average molecular weight and grafting ratio of the solvent-soluble fraction of the graft copolymer (A) can be easily adjusted to desired weight-average molecular weight and grafting ratio ranges by using a chain transfer agent. Examples of the chain transfer agent include (i) mercaptans, such as n-octyl mercaptan, t-dodecyl mercaptan, n-dodecyl mercaptan, n-tetradecyl mercaptan, and n-octadecyl mercaptan, and (ii) terpenes, such as terpinolene, and two or more of the chain transfer agents may be combined. Among chain transfer agents, n-octyl mercaptan and t-dodecyl mercaptan are preferable for use.

The added amount of the chain transfer agent used for the production of a graft copolymer (A) is not specifically limited. The added amount of the chain transfer agent used for the production of a graft copolymer (A) is preferably not less than 0.2 part by mass and more preferably not less than 0.4 part by mass and is preferably not more than 0.7 part by mass and more preferably not more than 0.6 part by mass, relative to the total of the rubber polymer (r) and the vinyl monomer mixture (a), which is taken as 100 parts by mass, for easily adjusting the weight-average molecular weight and grafting ratio of the solvent-soluble fraction of the graft copolymer (A) to the aforementioned weight-average molecular weight and grafting ratio ranges.

In the case of producing a graft copolymer (A) by the emulsion polymerization, the polymerization temperature is not limited to a specific temperature, but it is preferred that the temperature be not lower than 40° C. and not higher than 70° C., for easily adjusting the weight-average molecular weight of the solvent-soluble fraction of the graft copolymer (A) to the aforementioned weight-average molecular weight range and from the viewpoint of emulsification stability.

In the case of producing a graft copolymer (A) by the emulsion polymerization method, the graft copolymer (A) is generally recovered by adding a coagulant to a latex of the graft copolymer. An acid or a water-soluble salt is preferable for use as the coagulant.

Examples of the acid used as a coagulant include sulfuric acid, hydrochloric acid, phosphoric acid, and acetic acid. Examples of the water-soluble salt used as a coagulant include calcium chloride, magnesium chloride, barium chloride, aluminum chloride, magnesium sulfate, aluminum sulfate, aluminum ammonium sulfate, aluminum potassium sulfate, and aluminum sodium sulfate, and two or more of the water-soluble salts may be combined. It is preferred that no emulsifier be left in a finished resin composition, for providing a molded article with improved volatility. Therefore, it is preferred that a carboxylate salt-type emulsifier used as the emulsifier be coagulated with an acid and then removed by neutralization with an alkali, such as sodium hydroxide.

### Component 2: Vinyl Copolymer (B)

The vinyl copolymer (B) used in the resin composition is obtained by copolymerization of a monomer mixture (b) comprising at least an aromatic vinyl monomer (b1) and a vinyl cyanide monomer (b2). The vinyl monomer mixture (b) may further comprise another monomer that can be copolymerized with the aforementioned aromatic vinyl monomer (b1) and vinyl cyanide monomer (b2). However, the vinyl monomer mixture (b) comprises no maleimide monomer.

The aromatic vinyl monomer (b1) in the vinyl monomer mixture (b) can be any of the examples of the aromatic vinyl monomer (a1) and is preferably styrene.

The content of the aromatic vinyl monomer (b1) in the vinyl monomer mixture (b) is preferably not less than 60% by mass, more preferably not less than 65% by mass, still more preferably not less than 70% by mass, relative to the total of the vinyl monomer mixture (b), which is taken as 100% by mass, from the viewpoint of providing a finished resin composition with higher flowability and a molded article with higher stiffness. On the other hand, the content of the aromatic vinyl monomer (b1) in the vinyl monomer mixture (b) is preferably not more than 40% by mass, more preferably not more than 35% by mass, still more preferably not more than 30% by mass, relative to the total of the vinyl monomer mixture (b), which is taken as 100% by mass, from the viewpoint of providing a molded article with higher impact resistance.

The vinyl cyanide monomer (b2) in the vinyl monomer mixture (b) can be any of the examples of the vinyl cyanide monomer (a2) and is preferably acrylonitrile.

The content of the vinyl cyanide monomer (b2) in the vinyl monomer mixture (b) is preferably not less than 20% by mass, more preferably not less than 25% by mass, still more preferably not less than 30% by mass, relative to the total of the vinyl monomer mixture (b), which is taken as 100% by mass, for providing a molded article with higher impact resistance. Moreover, the content of the vinyl cyanide monomer (b2) in the vinyl monomer mixture (b) is preferably not more than 40% by mass, more preferably not more than 35% by mass, still more preferably not more than 30% by mass, relative to the total of the vinyl monomer mixture (b), which is taken as 100% by mass, for providing a finished resin composition with higher flowability and a molded article with an improved color tone.

The above-mentioned another monomer that can be copolymerized with the aforementioned aromatic vinyl monomer (b1) and vinyl cyanide monomer (b2) is not specifically limited, provided that the above-mentioned another monomer is a vinyl monomer other than the vinyl monomer (b1) and the vinyl cyanide monomer (b2) and does not impair the desired effects. Specific examples of the above-mentioned another monomer include (meth)acrylate monomers (b3), unsaturated fatty acids, and acrylamide monomers. Two or more of these monomers may be contained as the above-mentioned another monomer. However, the vinyl monomer mixture (b) comprises no maleimide monomer. Examples of the unsaturated fatty acids include itaconic acid, maleic acid, fumaric acid, butenoic acid, acrylic acid, and methacrylic acid. Examples of the acrylamide monomers include acrylamide, methacrylamide, and N-methyl-acrylamide.

The vinyl copolymer (B) preferably has a weight-average molecular weight of not less than 70,000 and more preferably not less than 80,000. In cases where the vinyl copolymer (B) has a weight-average molecular weight of not less than 70,000, a molded article with higher impact resistance can be provided. Moreover, the vinyl copolymer (B) has a weight-average molecular weight of not more than 200,000 and more preferably not more than 150,000. In cases where the vinyl copolymer (B) has a weight-average molecular weight of not more than 200,000, the finished resin composition can have higher flowability. A vinyl copolymer (B) with a weight-average molecular weight of not less than 70,000 and not more than 200,000 can be easily produced by, for example, using an initiator and a chain transfer agent described below and limiting the polymerization temperature to a preferred range of temperature described below.

In this respect, the weight-average molecular weight of the vinyl copolymer (B) can be determined from a chromatogram of a solution of the vinyl copolymer (B) obtained by GPC measurement, relative to polystyrene as a standard, which solution is obtained by dissolving about 0.03 g of the vinyl copolymer (B) in about 15 g of tetrahydrofuran to a concentration of about 0.2% by mass. Provided however, when (meth)acrylate monomer (a3) is used in the vinyl monomer mixture (a), polymethyl methacrylate is used as a standard. The GPC measurement can be performed under the following conditions.
Measuring instrument: Waters 2695
Column temperature: 40° C.
Detector: RI2414 (differential refractometer)
Flow rate of carrier solution (eluate): 0.3 ml/min (solvent: tetrahydrofuran)
Column: TSKgel SuperHZM-M (6.0 mm I.D.×15 cm) and TSKgel SuperHZM-N (6.0 mm I.D.×15 cm) connected in series (both are manufactured by TOSOH Corporation)

The production of a vinyl copolymer (B) is not limited to a specific method, but the continuous bulk polymerization process or the continuous solution polymerization process is preferable for use in view of the moldability of a finished resin composition and the color tone of a molded article. In this respect, the continuous bulk polymerization process is a method comprising continuously feeding a monomer mixture followed by bulk polymerization and then continuous discharge of the resulting vinyl copolymer, and the continuous solution polymerization process is a method comprising continuously feeding a monomer mixture and a solvent followed by solution polymerization and then continuous discharge of a solution of the resulting vinyl copolymer and the solvent.

An arbitrary method can be adopted as a method of producing a vinyl copolymer (B) by the continuous bulk polymerization process or the continuous solution polymerization process, and an example of the method can be a method comprising polymerizing a vinyl monomer mixture (b) in a polymerization vessel followed by monomer removal (removal of a solvent and volatile components).

Examples of a vessel that can be used as the polymerization vessel include mixer-type polymerization vessels equipped with a mixing impeller, such as paddle impeller, turbine impeller, propeller impeller, Brumargin impeller, multi-stage impeller, anchor impeller, MAXBLEND impeller, or double-helical impeller, and various types of tower-type reactors. Also, a multitube reactor, kneader-type reactor, a twin-screw extruder, and the like can be used as a polymerization reactor (see, for example, Assessment of Polymer Production Processes 10 “Assessment of Impact-Resistant Polystyrene” The Society of Polymer Science, Japan, Jan. 26, 1989).

For the production of the vinyl copolymer (B), two or more polymerization vessels or polymerization reactors as described above may be used, or two or more types of polymerization vessels or polymerization reactors as described above may be combined as needed. Preferably, two or less polymerization vessels or polymerization reactors, more preferably a single-chamber complete mixing polymerization vessel, are used for reducing the molecular weight distribution of the vinyl copolymer (B).

A reaction mixture obtained by polymerization in the polymerization vessel(s) or polymerization reactor(s) described above usually then undergoes a monomer removal step to remove monomers, a solvent, and other volatile components. Examples of a method for monomer removal include a method comprising heating volatile components in a vented single-screw or twin-screw extruder under normal pressure or reduced pressure to release the volatile components from the vent, a method comprising removing volatile components with an evaporator, such as centrifugal evaporator, equipped with a plate fin heater inside a drum of the evaporator, a method comprising removing volatile components with a thin film evaporator, such as centrifugal thin film evaporator, and a method comprising removing volatile components by preheating the volatile components with a multitube heat exchanger to produce foam and flushing the foam into a vacuum chamber. Among those methods for monomer removal, the method comprising removing volatile components with a vented single-screw or twin-screw extruder is especially preferable for use.

In the case of producing a vinyl copolymer (B), an initiator and/or a chain transfer agent may be used as appropriate. The initiator and chain transfer agent can be the same initiator and chain transfer agent as those indicated for the method of producing a graft copolymer (A).

The added amount of the initiator used for the production of the vinyl copolymer (B) is not specifically limited, but it is preferred that the amount of the initiator be not less than 0.01 part by mass and not more than 0.03 part by mass relative to 100 parts by mass of the total vinyl monomer mixture (b), from the viewpoint of easily adjusting the weight-average molecular weight of the vinyl copolymer (B) to the aforementioned weight-average molecular weight range.

The added amount of the chain transfer agent used for the production of the vinyl copolymer (B) is not specifically limited, but it is preferred that the amount of the chain transfer agent be not less than 0.05 part by mass and not more than 0.40 part by mass relative to 100 parts by mass of the total vinyl monomer mixture (b), for easily adjusting the weight-average molecular weight of the vinyl copolymer (B) to the aforementioned weight-average molecular weight range.

In the case of producing a vinyl copolymer (B) by the continuous bulk polymerization process or the continuous solution polymerization process, the polymerization temperature is not limited to a specific temperature, but it is preferred that the temperature be not lower than 120° C. and not higher than 140° C., for easily adjusting the weight-average molecular weight of the vinyl copolymer (B) to the aforementioned weight-average molecular weight range.

In the case of producing a vinyl copolymer (B) by the continuous solution polymerization process, the amount of a solvent is preferably not more than 30% by mass, more preferably not more than 20% by mass, of the polymerization solution from the viewpoint of productivity. As the solvent, ethylbenzene or methyl ethyl ketone, especially ethylbenzene, is preferable for use from the viewpoint of polymerization stability.

Preferably, the resin composition is formed by combining a graft copolymer (A) at a content of not less than 10 parts by mass and not more than 60 parts by mass and a vinyl copolymer (B) at a content of not less than 40 parts by mass and not more than 90 parts by mass, relative to the total of the graft copolymer (A) and the vinyl copolymer (B), which is taken as 100 parts by mass. The graft copolymer (A) content of not less than 10 parts by mass and the vinyl copolymer (B) content of not more than 90 parts by mass can prevent a molded article from having lower impact resistance. It is more preferred that the content of the graft copolymer (A) be not less than 20 parts by mass and the content of the vinyl copolymer (B) be not more than 80 parts by mass, relative to the total of the graft copolymer (A) and the vinyl copolymer (B), which is taken as 100 parts by mass. Moreover, the graft copolymer (A) content of not more than 60 parts by mass and the vinyl copolymer (B) content of not less than 40 parts by mass can prevent the finished resin composition from having an increased melt viscosity and a decreased flowability and also from reducing volatility, appearance and coloration efficiency. It is more preferred that the content of the graft copolymer (A) be not more than 50 parts by mass and the content of the vinyl copolymer (B) be not less than 50 parts by mass, relative to the total of the graft copolymer (A) and the vinyl copolymer (B), which is taken as 100 parts by mass. In this respect, a graft copolymer (A) comprising two or more different rubber polymers (r) may be included as the graft copolymer (A). Also, two or more vinyl copolymers (B) may be included as the vinyl copolymer (B).

### Component 3: Phosphate Compound (E1) and Polyoxyethylene Alkylamine (E2)

The resin composition comprises either or both of a phosphate compound (E1) represented by chemical formula (1) and a polyoxyethylene alkylamine (E2) represented by chemical formula (2).

The phosphate compound (E1) is represented by chemical formula (1):

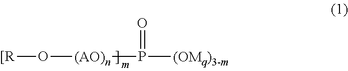

wherein R represents an alkyl or alkenyl group containing 8 to 22 carbon atoms; AO represents an oxyalkylene group containing 2 or 3 carbon atoms; n is an integer of 1 to 20; m is an integer of 1 or 2; M represents a hydrogen atom, a group I metal atom, or a group II metal atom; and q is 1 in cases where M is a hydrogen atom or a group I metal atom, or q is ½ in cases where M is a group II metal atom.

In chemical formula (1), R represents an alkyl or alkenyl group containing 8 to 22 carbon atoms. The alkyl group may be linear or branched or may contain a ring structure, such as a cycloalkyl structure. The number of carbon atoms in the alkyl group is preferably not less than 12 and is still more preferably not more than 16. Specifically, n-dodecyl, n-tridecyl, n-tetradecyl, and isotridecyl are preferred as a group represented by R.

AO represents an oxyalkylene group containing 2 or 3 carbon atoms. The oxyalkylene group may be linear or branched. Specifically, the oxyalkylene group is oxyethylene or oxypropylene.

M represents a hydrogen atom, a group I metal atom in the periodic table, or a group II metal atom in the periodic table. Examples of the group I metal atom include sodium, potassium, lithium, rubidium, and cesium, and examples of the group II metal atom include calcium, barium, magnesium, and strontium. Among those, hydrogen, sodium, potassium, calcium, and magnesium are preferred as an atom represented by M.

The number represented by n is an integer of 1 to 20, preferably an integer of not less than 3 and not more than 10. In cases where the number represented by m is not less than 2, the groups represented by AO may be different. Specifically, the compound may contain both an oxyethylene group and an oxypropylene group.

Examples of the phosphate compound (E1) represented by chemical formula (1) include, but are not limited to, linear alkyloxy polyoxyethylene phosphates, such as mono-n-dodecyl tetraoxyethylene phosphate, di-n-dodecyl tetraoxyethylene phosphate, mono-n-tridecyl tetraoxyethylene phosphate, di-n-tridecyl tetraoxyethylene phosphate, mono-n-tetradecyloxy tetraoxyethylene phosphate, di-n-tetradecyloxy tetraoxyethylene phosphate, mono-n-hexadecyloxy tetraoxyethylene phosphate, di-n-hexadecyloxy tetraoxyethylene phosphate, mono-n-octadecyloxy tetraoxyethylene phosphate, di-n-octadecyloxy tetraoxyethylene phosphate, mono-n-decyloxy pentaoxyethylene phosphate, di-n-decyloxy pentaoxyethylene phosphate, mono-n-dodecyloxy pentaoxyethylene phosphate, di-n-dodecyloxy pentaoxyethylene phosphate, mono-n-tridecyloxy pentaoxyethylene phosphate, di-n-tridecyloxy pentaoxyethylene phosphate, mono-n-tetradecyloxy pentaoxyethylene phosphate, di-n-tetradecyloxy pentaoxyethylene phosphate, mono-n-hexadecyloxy pentaoxyethylene phosphate, di-n-hexadecyloxy pentaoxyethylene phosphate, mono-n-octadecyloxy pentaoxyethylene phosphate, di-n-octadecyloxy pentaoxyethylene phosphate, mono-n-decyloxy hexaoxyethylene phosphate, di-n-decyloxy hexaoxyethylene phosphate, mono-n-dodecyloxy hexaoxyethylene phosphate, di-n-dodecyloxy hexaoxyethylene phosphate, mono-n-tridecyloxy hexaoxyethylene phosphate, di-n-tridecyloxy hexaoxyethylene phosphate, mono-n-tetradecyloxy hexaoxyethylene phosphate, di-n-tetradecyloxy hexaoxyethylene phosphate, mono-n-hexadecyloxy hexaoxyethylene phosphate, di-n-hexadecyloxy hexaoxyethylene phosphate, mono-n-octadecyloxy hexaoxyethylene phosphate, di-n-octadecyloxy hexaoxyethylene phosphate, mono-n-decyloxy octaoxyethylene phosphate, di-n-decyloxy octaoxyethylene phosphate, mono-n-dodecyloxy octaoxyethylene phosphate, di-n-dodecyloxy octaoxyethylene phosphate, mono-n-tridecyloxy octaoxyethylene phosphate, di-n-tridecyloxy octaoxyethylene phosphate, mono-n-tetradecyloxy octaoxyethylene phosphate, di-n-tetradecyloxy octaoxyethylene phosphate, mono-n-hexadecyloxy octaoxyethylene phosphate, di-n-hexadecyloxy octaoxyethylene phosphate, mono-n-octadecyloxy octaoxyethylene phosphate, and di-n-octadecyloxy octaoxyethylene phosphate, or group I metal (alkali metal, such as Na or K) salts thereof or group II metal (alkali earth metal, such as Ca or Mg) salts thereof, and branched alkyloxy polyoxyethylene phosphates, such as mono-n-isodecyloxy tetraoxyethylene phosphate, di-n-isodecyloxy tetraoxyethylene phosphate, mono-n-isododecyloxy tetraoxyethylene phosphate, di-n-isododecyloxy tetraoxyethylene phosphate, mono-n-isotridecyloxy tetraoxyethylene phosphate, di-n-isotridecyloxy tetraoxyethylene phosphate, mono-n-isotetradecyloxy tetraoxyethylene phosphate, di-n-isotetradecyloxy tetraoxyethylene phosphate, mono-n-isohexadecyloxy tetraoxyethylene phosphate, di-n-isohexadecyloxy tetraoxyethylene phosphate, mono-n-isooctadecyloxy tetraoxyethylene phosphate, di-n-isooctadecyloxy tetraoxyethylene phosphate, mono-n-isodecyloxy hexaoxyethylene phosphate, di-n-isodecyloxy hexaoxyethylene phosphate, mono-n-isododecyloxy hexaoxyethylene phosphate, di-n-isododecyloxy hexaoxyethylene phosphate, mono-n-isotridecyloxy hexaoxyethylene phosphate, di-n-isotridecyloxy hexaoxyethylene phosphate, mono-n-isotetradecyloxy hexaoxyethylene phosphate, di-n-isotetradecyloxy hexaoxyethylene phosphate, mono-n-isohexadecyloxy hexaoxyethylene phosphate, di-n-isohexadecyloxy hexaoxyethylene phosphate, mono-n-isooctadecyloxy hexaoxyethylene phosphate, di-n-isooctadecyloxy hexaoxyethylene phosphate, mono-n-isodecyloxy octaoxyethylene phosphate, di-n-isodecyloxy octaoxyethylene phosphate, mono-n-isododecyloxy octaoxyethylene phosphate, di-n-isododecyloxy octaoxyethylene phosphate, mono-n-isotridecyloxy octaoxyethylene phosphate, di-n-isotridecyloxy octaoxyethylene phosphate, mono-n-isotetradecyloxy octaoxyethylene phosphate, di-n-isotetradecyloxy octaoxyethylene phosphate, mono-n-isohexadecyloxy octaoxyethylene phosphate, di-n-isohexadecyloxy octaoxyethylene phosphate, mono-n-isooctadecyloxy octaoxyethylene phosphate, and di-n-isooctadecyloxy octaoxyethylene phosphate, or group I metal (alkali metal, such as Na or K) salts thereof or group II metal (alkali earth metal, such as Ca or Mg) salts thereof. Among those, mono-n-dodecyloxy tetraoxyethylene phosphate, mono-n-isododecyloxy tetraoxyethylene phosphate, mono-n-tridecyloxy hexaoxyethylene phosphate, or mono-n-isotridecyloxy hexaoxyethylene phosphate, or a group I metal (alkali metal, such as Na or K) salt thereof, or a group II metal (alkali earth metal, such as Ca or Mg) salt thereof is preferably used for providing a molded article with an improved appearance and a higher coloration efficiency.

Additionally, other examples of the phosphate compound represented by chemical formula (1) include, but are not limited to, linear alkyloxy polyoxyethylene phosphates, such as mono-n-dodecyl tetraoxypropylene phosphate, di-n-dodecyl tetraoxypropylene phosphate, mono-n-tridecyl tetraoxypropylene phosphate, di-n-tridecyl tetraoxypropylene phosphate, mono-n-tetradecyloxy tetraoxypropylene phosphate, di-n-tetradecyloxy tetraoxypropylene phosphate, mono-n-hexadecyloxy tetraoxypropylene phosphate, di-n-hexadecyloxy tetraoxypropylene phosphate, mono-n-octadecyloxy tetraoxypropylene phosphate, di-n-octadecyloxy tetraoxypropylene phosphate, mono-n-decyloxy pentaoxypropylene phosphate, di-n-decyloxy pentaoxypropylene phosphate, mono-n-dodecyloxy pentaoxypropylene phosphate, di-n-dodecyloxy pentaoxypropylene phosphate, mono-n-tridecyloxy pentaoxypropylene phosphate, di-n-tridecyloxy pentaoxypropylene phosphate, mono-n-tetradecyloxy pentaoxypropylene phosphate, di-n-tetradecyloxy pentaoxypropylene phosphate, mono-n-hexadecyloxy pentaoxypropylene phosphate, di-n-hexadecyloxy pentaoxypropylene phosphate, mono-n-octadecyloxy pentaoxypropylene phosphate, di-n-octadecyloxy pentaoxypropylene phosphate, mono-n-decyloxy hexaoxypropylene phosphate, di-n-decyloxy hexaoxypropylene phosphate, mono-n-dodecyloxy hexaoxypropylene phosphate, di-n-dodecyloxy hexaoxypropylene phosphate, mono-n-tridecyloxy hexaoxypropylene phosphate, di-n-tridecyloxy hexaoxypropylene phosphate, mono-n-tetradecyloxy hexaoxypropylene phosphate, di-n-tetradecyloxy hexaoxypropylene phosphate, mono-n-hexadecyloxy hexaoxypropylene phosphate, di-n-hexadecyloxy hexaoxypropylene phosphate, mono-n-octadecyloxy hexaoxypropylene phosphate, di-n-octadecyloxy hexaoxypropylene phosphate, mono-n-decyloxy octaoxypropylene phosphate, di-n-decyloxy octaoxypropylene phosphate, mono-n-dodecyloxy octaoxypropylene phosphate, di-n-dodecyloxy octaoxypropylene phosphate, mono-n-tridecyloxy octaoxypropylene phosphate, di-n-tridecyloxy octaoxypropylene phosphate, mono-n-tetradecyloxy octaoxypropylene phosphate, di-n-tetradecyloxy octaoxypropylene phosphate, mono-n-hexadecyloxy octaoxypropylene phosphate, di-n-hexadecyloxy octaoxypropylene phosphate, mono-n-octadecyloxy octaoxypropylene phosphate, and di-n-octadecyloxy octaoxypropylene phosphate, or group I metal (alkali metal, such as Na or K) salts thereof or group II metal (alkali earth metal, such as Ca or Mg) salts thereof, and branched alkyloxy polyoxypropylene phosphates, such as mono-n-isodecyloxy tetraoxypropylene phosphate, di-n-isodecyloxy tetraoxypropylene phosphate, mono-n-isododecyloxy tetraoxypropylene phosphate, di-n-isododecyloxy tetraoxypropylene phosphate, mono-n-isotridecyloxy tetraoxypropylene phosphate, di-n-isotridecyloxy tetraoxypropylene phosphate, mono-n-isotetradecyloxy tetraoxypropylene phosphate, di-n-isotetradecyloxy tetraoxypropylene phosphate, mono-n-isohexadecyloxy tetraoxypropylene phosphate, di-n-isohexadecyloxy tetraoxypropylene phosphate, mono-n-isooctadecyloxy tetraoxypropylene phosphate, di-n-isooctadecyloxy tetraoxypropylene phosphate, mono-n-isodecyloxy hexaoxypropylene phosphate, di-n-isodecyloxy hexaoxypropylene phosphate, mono-n-isododecyloxy hexaoxypropylene phosphate, di-n-isododecyloxy hexaoxypropylene phosphate, mono-n-isotridecyloxy hexaoxypropylene phosphate, di-n-isotridecyloxy hexaoxypropylene phosphate, mono-n-isotetradecyloxy hexaoxypropylene phosphate, di-n-isotetradecyloxy hexaoxypropylene phosphate, mono-n-isohexadecyloxy hexaoxypropylene phosphate, di-n-isohexadecyloxy hexaoxypropylene phosphate, mono-n-isooctadecyloxy hexaoxypropylene phosphate, di-n-isooctadecyloxy hexaoxypropylene phosphate, mono-n-isodecyloxy octaoxypropylene phosphate, di-n-isodecyloxy octaoxypropylene phosphate, mono-n-isododecyloxy octaoxypropylene phosphate, di-n-isododecyloxy octaoxypropylene phosphate, mono-n-isotridecyloxy octaoxypropylene phosphate, di-n-isotridecyloxy octaoxypropylene phosphate, mono-n-isotetradecyloxy octaoxypropylene phosphate, di-n-isotetradecyloxy octaoxypropylene phosphate, mono-n-isohexadecyloxy octaoxypropylene phosphate, di-n-isohexadecyloxy octaoxypropylene phosphate, mono-n-isooctadecyloxy octaoxypropylene phosphate, and di-n-isooctadecyloxy octaoxypropylene phosphate, or group I metal (alkali metal, such as Na or K) salts thereof or group II metal (alkali earth metal, such as Ca or Mg) salts thereof. Among those, mono-n-dodecyloxy tetraoxypropylene phosphate, mono-n-isododecyloxy tetraoxypropylene phosphate, mono-n-tridecyloxy hexaoxypropylene phosphate, or mono-n-isotridecyloxy hexaoxypropylene phosphate, or a group I metal (alkali metal, such as Na or K) salt thereof, or a group II metal (alkali earth metal, such as Ca or Mg) salt thereof is preferably used for providing a molded article with an improved appearance and a higher coloration efficiency.

These phosphate compounds (E1) may be used singly or in combination of two or more. In cases where a combination of two or more of the phosphate compounds is used, the combination may be a mixture of monoalkyl and dialkyl esters. In this case, the mixture of monoalkyl and dialkyl esters is not limited to a specific mixture ratio.

Commercial products containing a phosphate compound (E1) represented by chemical formula (1) include, for example, NC-718 manufactured by Sanyo Chemical Industries, Ltd., Phosphanol LS-529, Phosphanol RS-610, Phosphanol RD-510Y, Phosphanol RS-620, Phosphanol RS-630, Phosphanol RS-640, Phosphanol RS-650, Phosphanol RS-660, and Phosphanol RS-6103C, which are manufactured by TOHO Chemical Industry Co., Ltd., and LATEMUL P-0405, LATEMUL P-0406, and LATEMUL P-0407, which are manufactured by Kao Corporation.

For the phosphate compounds (E1), it is more preferred that a part of the atoms represented by M in chemical formula (1) be a group II metal atom. If a part of the atoms represented by M in chemical formula (1) is a group II metal atom, the appearance, coloration efficiency, and tensile elongation are further improved in a molded article. Among those, calcium is preferable for use.

In cases where each of the atoms represented by M is a group II metal atom, the number represented by q is ½ because a divalent metal atom interacts with two monovalent phosphate molecules.

In a phosphate compound (E1), the content of a group II metal atom is more preferred to be not less than 2% by mass and not more than 5% by mass relative to the phosphate compound (E1), which is taken as 100% by mass. When the content of a group II metal atom in a phosphate compound (E1) is not less than 2% by mass relative to the phosphate compound (E1), which is taken as 100% by mass, the appearance, coloration efficiency, and tensile elongation can be further improved in a molded article. On the other hand, it is undesired that the content of a group II metal atom in a phosphate compound (E1) is more than 5% by mass relative to the phosphate compound (E1), which is taken as 100% by mass, because in that case the viscosity of an aqueous solution containing the phosphate compound (E1) will be increased, which may reduce the solubility of the phosphate compound (E1) in an emulsion polymer latex as described below and in turn deteriorate the emulsification stability of the latex when the aqueous solution containing the phosphate compound (E1) is blended with the latex.

An aqueous solution of a phosphate compound (E1) that contains a group II metal atom at a content of not less than 2% by mass and not more than 5% by mass relative to the phosphate compound (E1), which is taken as 100% by mass, can be easily produced by adding a predetermined amount of a hydroxide of a group II metal atom, specifically calcium hydroxide or the like, to a commercial product containing the phosphate compound (E1) and stirring the resulting mixture at 60° C. for around 30 minutes.

The polyoxyethylene alkylamine (E2) is represented by chemical formula (2):

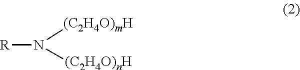

In chemical formula (2), R represents an alkyl or alkenyl group containing 8 to 22 carbon atoms; and m and n are positive integers that satisfy the formula: 2<m+n≤20.

Examples of the polyoxyethylene alkylamine (E2) represented by chemical formula (2) include, but are not limited to, N,N-di(polyoxyethylene)-N-laurylamine (3), N,N-di(polyoxyethylene)-N-laurylamine (10), N,N-di(polyoxyethylene)-N-myristylamine (4), N,N-di(polyoxyethylene)-N-myristylamine (6), N,N-di(polyoxyethylene)-N-palmitylamine (5), N,N-di(polyoxyethylene)-N-stearylamine (9), N,N-di(polyoxyethylene)-N-oleylamine (8), and N,N-di(polyoxyethylene)-N-behenylamine (3). These polyoxyethylene alkylamines (E2) may be used singly or in combination of two or more. In this respect, the number in each parenthesis indicates the sum of m+n.

The polyoxyethylene alkylamine (E2) represented by chemical formula (2) is produced by addition reaction of an aliphatic amine containing 8 to 22 carbon atoms and ethylene oxide or by dehydration reaction between an aliphatic amine and a polyoxyethylene. As the fatty acid amine, generally, saturated aliphatic amines containing 8 to 22 carbon atoms, such as laurylamine, myristylamine, and stearylamine, are used singly, or a mixture of any of the saturated amines and an unsaturated aliphatic amine such as oleylamine (for example, a higher aliphatic amine produced from a raw material such as coconut oil or beef tallow) is used.

Commercial products containing a polyoxyethylene alkylamine (E2) represented by chemical formula (2) include, for example, NYMEEN L-202, NYMEEN L-207, NYMEEN F-202, NYMEEN F-215, NYMEEN T2-210, NYMEEN T2-230, NYMEEN S-210, NYMEEN S-215, NYMEEN S-220, and NYMEEN 0-205, which are manufactured by NOF Corporation, and ANSTEX SA-35B manufactured by TOHO Chemical Industry Co., Ltd., and SN-WET S manufactured by San Nopco Limited.

The resin composition comprises either or both of a phosphate compound (E1) and a polyoxyethylene alkylamine (E2), wherein the ratio of total amount of the phosphate compound (E1) and the polyoxyethylene alkylamine (E2) to the whole resin composition is not less than 60 ppm (mass/mass). The ratio is preferably not less than 120 ppm (mass/mass) and more preferably not less than 300 ppm (mass/mass). In addition, the upper limit of the ratio is preferably up to 600 ppm (mass/mass). In cases where the ratio of total amount of the phosphate compound (E1) and the polyoxyethylene alkylamine (E2) to the whole resin composition is less than 60 ppm (mass/mass), the tensile elongation, appearance, and coloration efficiency are reduced in a molded article. On the other hand, it is undesired that the ratio is more than 600 ppm (mass/mass), because the volatility may be significantly reduced.

Preferably, the phosphate compound (E1) and the polyoxyethylene alkylamine (E2) are added to an emulsion latex of a graft copolymer (A) obtained by graft copolymerization, for the reason described below.

The total amount of either or both of the added phosphate compound (E1) and the added polyoxyethylene alkylamine (E2) is preferably not less than 0.04 parts by mass and less than 0.4 part by mass, more preferably not less than 0.04 part by mass and not more than 0.2 part by mass, relative to 100 parts by mass of the graft copolymer (A). In cases where the total amount of either or both of the phosphate compound (E1) and the polyoxyethylene alkylamine (E2) is not less than 0.04 part by mass relative to 100 parts by mass of the graft copolymer (A), the tensile elongation, appearance, and coloration efficiency can be improved in a molded article. On the other hand, in cases where the total amount of either or both of the phosphate compound (E1) and the polyoxyethylene alkylamine (E2) is less than 0.4 part by mass, a significant deterioration of the emulsion stability of the graft copolymer (A) latex can be prevented.

### Component 4: Heat-Resistant Vinyl Copolymer (C) Obtained by Copolymerization of Vinyl Monomer Mixture (c) Comprising at Least Aromatic Vinyl Monomer (c1) and Maleimide Monomer (c2)

The resin composition may optionally comprise a heat-resistant vinyl copolymer (C) obtained by copolymerization of a vinyl monomer mixture (c) comprising at least an aromatic vinyl monomer (c1) and a maleimide monomer (c2). The presence of the heat-resistant vinyl copolymer (C) can provide a finished resin composition with heat resistance.

The aromatic vinyl monomer (c1) in the vinyl monomer mixture (c) can be any of the examples of the aromatic vinyl monomer (a1) and is preferably styrene.

Examples of the maleimide monomer (c2) in the vinyl monomer mixture (c) include N-methylmaleimide, N-isopropylmaleimide, N-butylmaleimide, N-hexylmaleimide, N-octylmaleimide, N-dodecylmaleimide, N-cyclohexylmaleimide, and N-phenylmaleimide as well as corresponding maleic acid or maleic anhydride thereof (in the case maleic acid or maleic anhydride is used, imidization by amine compound be followed before or after copolymerization of the vinyl monomer mixture (c)). Two or more of these monomers may be contained as the maleimide monomer (c2). Among those monomers, N-phenylmaleimide is preferred as the maleimide monomer (c2) for providing a finished resin composition with higher heat resistance.

Moreover, another monomer is not specifically limited, provided that the above-mentioned another monomer is a vinyl monomer other than the aromatic vinyl monomer (c1) and the maleimide monomer (c2) and does not impair the desired effects. Specific examples of the above-mentioned another monomer include vinyl cyanide monomer (c3), unsaturated fatty acids, and acrylamide monomers. Two or more of these monomers may be contained as the above-mentioned another monomer.

The vinyl cyanide monomer (c3) in the vinyl monomer mixture (c) can be any of the examples of the vinyl cyanide monomer (a2) and is preferably acrylonitrile.

The ratio of the monomers used to constitute the heat-resistant vinyl copolymer (C) is not specifically limited, but it is preferred that the content of the aromatic vinyl monomer (c1) is 36% to 65% by mass, and that the content of the maleimide monomer (c2) is 35% to 52% by mass, preferably 37% to 50% by mass, and that the content of the vinyl cyanide monomer (c3) is 0% to 12% by mass. In particular, the maleimide monomer (c2) is less effective to improve heat resistance in the finished resin composition when the content of the maleimide monomer (c2) is less than 35% by mass. Moreover, the moldability of the finished resin composition may be compromised when the content of the maleimide monomer (c2) is more than 52% by mass.

Preferably, a dimethyl sulfoxide solution of the heat-resistant vinyl copolymer (C) at 30° C. and a concentration of 0.4 g/dl has a reduced viscosity of 0.3 dl/g to 0.7 dl/g, more preferably 0.4 dl/g to 0.6 dl/g, as measured with an Ubbelohde viscometer. In cases where the heat-resistant vinyl copolymer (C) has a reduced viscosity of less than 0.3 dl/g, a molded article with lower impact resistance may be provided. On the other hand, in cases where the heat-resistant vinyl copolymer (C) has a reduced viscosity of more than 0.7 dl/g, the finished resin composition may have lower flowability and moldability.

The amount of the heat-resistant vinyl copolymer (C) contained in the resin composition is preferably 10% to 38% by mass, more preferably 12% to 36% by mass, still more preferably 15% to 35% by mass, relative to the total of all the resin components, which is taken as 100% by mass. When the content of the heat-resistant vinyl copolymer (C) is within the above range, the improving effect on the heat resistance of a molded article is further enhanced, and the impact resistance of a molded article and the flowability of a finished resin composition are more significantly improved.

With respect to the case of using a heat-resistant vinyl copolymer (C), a phosphate compound (E1) comprises three parts consisting of a long-chain alkyl or alkenyl group (a hydrophobic part), a polyoxyalkylene group (a hydrophilic part), and a phosphate group (a polar part) in the molecular structure, and a polyoxyethylene alkylamine (E2) comprises three parts consisting of a long-chain alkyl or alkenyl group (a hydrophobic part), a polyoxyalkylene group (a hydrophilic part), and a tertiary amino group (a polar part) in the molecular structure, and the hydrophobic parts are compatible with a rubber polymer (r) in a graft copolymer (A), and, on the other hand, the hydrophilic parts and the polar parts are compatible with highly polar nitrile or imide groups of a vinyl copolymer (B) or a heat-resistant vinyl copolymer (C). As a result, the phosphate compound (E1) and the polyoxyethylene alkylamine (E2) play a role of compatibilizer. The phosphate compound (E1) and the polyoxyethylene alkylamine (E2) prevent the rubber polymer (r) in the graft copolymer (A) from aggregating, which is believed to contribute to the excellent appearance and the good coloration efficiency. Specifically, a combination of an acrylic rubber, which contains a relatively small number of double bonds and tends to have a lower grafting ratio, and a particularly highly polar heat-resistant vinyl copolymer (C) is highly likely to promote aggregation of the acrylic rubber in a graft copolymer (A), but the aggregation of the acrylic rubber in the graft copolymer (A) can be prevented by adding either or both of a phosphate compound (E1) and a polyoxyethylene alkylamine (E2). In addition, this effect of the phosphate compound (E1) and the polyoxyethylene alkylamine (E2) is particularly pronounced in the case of using a heat-resistant vinyl copolymer (C).

For effectively enhancing the effect even further, it is preferred that the phosphate compound (E1) and the polyoxyethylene alkylamine (E2) be added to the emulsion latex of the graft copolymer (A) to surround the graft copolymer (A).

The amount of the rubber polymer(r) contained in the resin composition is preferably 10% to 35% by mass, more preferably 15% to 30% by mass, still more preferably 15% to 25% by mass, relative to the total of all the resin components, which is taken as 100% by mass. In case where the content of the rubber polymer(r) is not less than 10% by mass, a molded article with the higher impact resistance and higher tensile elongation can be provided. On the other hand, in case where the content of the rubber polymer(r) is not more than 35% by mass, the finished resin composition can have higher flowability and a molded article with an improved appearance, and a higher coloration effectivity can be provided.

Examples of agents that the resin composition may contain to the extent that the desired effects are not impaired include inorganic fillers, such as glass fiber, glass powder, glass beads, glass flakes, alumina, alumina fiber, carbon fiber, graphite fiber, stainless fiber, whisker, potassium titanate fiber, wollastonite, asbestos, hard clay, calcined clay, talc, kaolin, mica, calcium carbonate, magnesium carbonate, aluminum oxide, and minerals; impact modifiers, such as silicone compounds; antioxidants, such as hindered phenolic antioxidants, and sulfur-containing or organic phosphorus-containing antioxidant compounds; heat stabilizers, such as phenolic and acrylate heat stabilizers; ultraviolet absorbing agents, such as benzotriazol, benzophenone and salicylate ultraviolet absorbing agents; hindered amine photostabilizers; lubricants and plasticizers, such as higher fatty acid, acid ester, acid amide, and higher alcohol lubricants and plasticizers; mold releasing agents, such as montanoic acid and salts or esters or half-esters thereof, stearyl alcohol, stearyl amide, and ethylene wax; various flame retardants; flame retardant promoters; color retention agents, such as phosphite salts and hypophosphate salts; neutralizing agents, such as phosphoric acid, sodium dihydrogen phosphate, maleic anhydride, and succinic anhydride; nucleating agents; antistatic agents, such as amine, sulfonate, and polyether antistatic agents; coloring agents, such as carbon black, pigments, and dyes; and bluing agents.

Next, our method of producing a resin composition will be described. The resin composition can be obtained, for example, by the following steps: step (A) of producing an emulsion polymer latex obtained by graft copolymerization of a monomer mixture (a) comprising at least an aromatic vinyl monomer (a1) and a vinyl cyanide monomer (a2) in the presence of a rubber polymer (r), and adding either or both of a phosphate compound (E1) and a polyoxyethylene alkylamine (E2) to the emulsion polymer latex, and later allowing the emulsion polymer latex to contact an aqueous sulfuric acid solution to produce a graft copolymer (A); step (B) of producing a vinyl copolymer (B) obtained by copolymerization of a monomer mixture (b) comprising at least an aromatic vinyl monomer (b1) and a vinyl cyanide monomer (b2); optional step (C) of producing a heat-resistant vinyl copolymer (C) obtained by copolymerization of a vinyl monomer mixture (c) comprising at least an aromatic vinyl monomer (c1) and a maleimide monomer (c2); and the step of mixing the graft copolymer (A), vinyl copolymer (B), and heat-resistant vinyl copolymer (C) obtained in steps (A), (B), and (C) (provided that the heat-resistant vinyl copolymer (C) is an optional component). The melt mixing process is not limited to a specific method, but a method comprising, for example, using a vented cylinder equipped with a heater and a single-screw or twin-screw kneader for melt mixing can be adopted. The temperature for heating during the melt mixing is normally selected from the temperature range of 210° C. to 320° C., but the temperature gradient during the melt mixing process and the like can be set freely to the extent that the desired effects are not impaired. In cases where a twin-screw kneader is used, the screws may rotate in the same direction or in opposite directions.

The resin composition can be molded by an arbitrary molding method. Examples of the molding method include injection molding, extrusion molding, inflation molding, blow molding, vacuum molding, compression molding, and gas-assist molding, and injection molding is preferable for use. During injection molding, the temperature of the cylinder is preferably not lower than 210° C. and not higher than 320° C., and the temperature of a mold is preferably not lower than 30° C. and not higher than 80° C.

The resin composition can be widely used as molded articles with arbitrary shapes. Examples of the molded articles include films, sheets, fibers, fabrics, non-woven fabrics, injection molded articles, extrusion molded articles, vacuum molded articles, blow molded articles, and composites with other materials.

The resin compositions have effects against deterioration of appearance (fish-eye formation, glossiness) and reduction of coloration efficiency, impact resistance, and tensile elongation, which all result from aggregation of a rubber polymer, and are therefore useful for applications, such as home electric appliances, telecommunication devices, daily necessities and automobile components. Heat-resistant vinyl copolymer-containing resin compositions, which are made heat resistant, have an adequate level of both flowability and impact resistance for large-size molded articles and allow molded articles to have excellent appearance and are therefore especially preferably used for car exterior parts, such as rear spoilers, wheel caps, door mirrors, radiator grilles, and lamp housings, and car interior parts, such as power window panels, center console panels, center cluster panels, control levers, and console boxes.

### EXAMPLES

Our compositions, methods, and molded articles will be described in more detail by the following examples, but this disclosure is not construed as being limited to the examples. First, evaluation methods will be described.

### (1) Volume-Average Particle Size of Rubber Polymer

A latex of a rubber polymer (r) was diluted and dispersed in an aqueous medium and then analyzed with a laser scattering-diffraction particle size distribution meter “LS 13 320XR” (Beckman Coulter, Inc.) to measure particle size distribution. The volume-average particle size of the rubber polymer (r) was calculated based on the particle size distribution.

### (2) Grafting Ratio of Graft Copolymer (A)

To about 1 g of a graft copolymer (A), 80 ml of a solvent is added, and the resulting mixture is refluxed in a hot water bath at 70° C. for 3 hours. This solution is centrifuged at 8000 rpm (10,000 G) for 40 minutes, and an insoluble fraction is then filtered to obtain a solvent-insoluble fraction. The obtained solvent-insoluble fraction is dried at 80° C. under reduced pressure for 5 hours to measure the mass (the mass is represented by “n” in the formula below). The grafting ratio is calculated according to the formula below. In this formula, m represents the mass of the used sample of the graft copolymer (A), and X represents the content (% by mass) of a rubber polymer in the graft copolymer (A):

$$Grafting ratio ( \% ) = \{ [ ( n ) - ( ( m ) \times X / 100 ) ] / [ ( m ) \times X / 100 ] \} \times 100.$$

In this respect, acetone and acetonitrile were respectively used as solvents for the cases of using a polybutadiene and an acrylic rubber as the rubber polymer (r).

### (3) Amounts of Phosphate Compound (E1) and Polyoxyethylene Alkylamine (E2) in Resin Composition

To 0.1 g of a resin composition, 10 ml of chloroform was added, and the resulting mixture was left to stand for 12 hours. Subsequently, the mixture was treated with ultrasonics for 1 hour, and 0.1 mL of the prepared solution was transferred into a micro-test tube. The prepared solution was diluted 10 times by adding 0.9 mL of methanol containing formic acid at a concentration of 1% by volume, and the resulting mixture was vigorously stirred. The mixture was then centrifuged (15,000 G) for 15 minutes, and the supernatant was prepared as a sample solution.

The sample solution was analyzed by LC/MS under the following conditions. Three kinds of ions were selected to be monitored, and the monitored ions were compared to those in a standard curve obtained for each previously prepared standard solution to measure the amounts of a phosphate compound (E1) and a polyoxyethylene alkylamine (E2) in the resin composition, and the numerical average of the measured amounts was calculated.

### Measurement Conditions of Phosphate Compound (E1):

HPLC: LC-20 (manufactured by Shimadzu Corporation)
Mass spectrometer: API5000 (manufactured by Sciex)
Column: ODS column
Mobile phase: A. 10 mmol/L ammonium acetate in water
   B. acetonitrile
   in gradient
Injection volume: 3 μL
Ionization: APCI
Detection: negative ion detection
Measurement mode: SRM (selected reaction monitoring)

### Monitored Ions:

tridecyloxy pentaoxyethylene phosphate*(Q1 m/z: 499.5, Q3 m/z: 79.0)
tridecyloxy hexaoxyethylene phosphate*(Q1 m/z: 543.5, Q3 m/z: 79.0)
tridecyloxy heptaoxyethylene phosphate*(Q1 m/z: 587.5, Q3 m/z: 79.0)
The ions [M−H]⁻ were selected as the ions to be monitored.

### Measurement Conditions of Polyoxyethylene Alkylamine (E2):

HPLC: LC-20 (manufactured by Shimadzu Corporation)
Mass spectrometer: API5000 (manufactured by Sciex)
Column: ODS column
Mobile phase: A. 10 mmol/L ammonium acetate in water
   B. acetonitrile
   in gradient
Injection volume: 2 μL
Ionization: APCI
Detection: positive ion detection
Measurement mode: SRM (selected reaction monitoring)

### Monitored Ions:

N,N-dipolyoxyethylene-N-lauryl amine (4, 5)*(Q1 m/z: 582.5, Q3 m/z: 344.4)
N,N-dipolyoxyethylne-N-lauryl amine (5, 5)*(Q1 m/z: 626.6, Q3 m/z: 344.4)
N,N-dipolyoxyethylene-N-lauryl amine (5, 6)*(Q1 m/z: 626.6, Q3 m/z: 344.4)
The ions [M+H]⁺ were selected as the ions to be monitored.

The number in parenthesis means m and n respectively as defined in said chemical formula (2).

### (4) Amount of Coagulum

In a 500-L beaker, 100 g (solid content) of an emulsion latex of a graft copolymer comprising a rubber polymer as a core was placed and stirred with a stirred at a stirring speed of 500 rpm for 15 minutes, and the latex was then filtered through a wire grid with a mesh size of 100, and the coagulum collected on the grid was washed with water and then dried in a dryer at 150° C. for 15 minutes to determine the mass of the dried coagulum. Grade A is given to the best results.
A: the mass of the coagulum is less than 0.5 g;
B: the mass of the coagulum is not less than 0.5 g but less than 1.5 g;
C: the mass of the coagulum is not less than 1.5 g.

### (5) Evaluation of Impact Resistance (Charpy Impact Strength)

Each resin composition prepared as a pellet sample was dried in a hot air dryer at 80° C. for 3 hours and then charged into a molding machine SE-50DU, manufactured by Sumitomo Heavy Industries, Ltd., at a cylinder temperature of 230° C. to form 4-mm-thick dumbbell-shaped test pieces at a mold temperature of 60° C. with a molding cycle of 30 seconds. Five of the obtained dumbbell-shaped test pieces were analyzed by a method in accordance with ISO 179 to measure the Charpy impact strength, and the numerical average of the measured values was calculated.

### (6) Evaluation of Tensile Elongation (Tensile Elongation)

Each resin composition prepared as a pellet sample was dried in a hot air dryer at 80° C. for 3 hours and then charged into a molding machine SE-50DU, manufactured by Sumitomo Heavy Industries, Ltd., at a cylinder temperature of 230° C. to form 4-mm-thick dumbbell-shaped test pieces at a mold temperature of 60° C. with a molding cycle of 30 seconds. Five of the obtained dumbbell-shaped test pieces were analyzed by a method in accordance with ISO 527 to measure the tensile elongation, and the numerical average of the measured values was calculated.

### (7) Evaluation of Appearance (Glossiness)

Each resin composition prepared as a pellet sample was dried in a hot air dryer at 80° C. for 3 hours and then charged into a molding machine SE-50DU, manufactured by Sumitomo Heavy Industries, Ltd., at a cylinder temperature of 250° C. to form molded plates (length: 90 mm, width: 50 mm, thickness: 2.5 mm) at an injection speed of 50 mm/s and a mold temperature of 60° C. with a molding cycle of 20 seconds. Five of the obtained molded plates were subjected to gloss measurement at 200 according to JIS Z8741 (1997), and the numerical average of the measured values was calculated.

### (8) Evaluation of Coloration Efficiency (L Value)

Each resin composition prepared as a pellet sample was dried in a hot air dryer at 80° C. for 3 hours and then charged into a molding machine SE-50DU, manufactured by Sumitomo Heavy Industries, Ltd., at a cylinder temperature of 250° C. to form molded plates (length: 90 mm, width: 50 mm, thickness: 2.5 mm) at an injection speed of 50 mm/s and a mold temperature of 60° C. with a molding cycle of 20 seconds. Five of the obtained molded plates were analyzed according to JIS K7103 (1971) to determine the L value, and the numerical average of the measured values was calculated. Lower L value is given to the best result.

### (9) Evaluation of Volatility (Mold Contamination)

Each resin composition prepared as a pellet sample was dried in a hot air dryer at 80° C. for 3 hours and then charged into a PS-60E molding machine, manufactured by Nissei Plastic Industrial Co., Ltd., at a cylinder temperature of 280° C. to form molded plates (length: 100 mm, width: 120 mm, thickness: 3 mm) by 1000 shots of injection molding at a mold temperature of 60° C. with a molding cycle of 30 seconds. Subsequently, the evaluation of mold contamination was performed based on the following criteria. Grade A is given to the best results.
A: no change is found on the surface of a mold;
B: a haze on the surface of a mold is found;
C: a mold surface is fouled, so that the appearance of a molded article is degraded.

### (10) Evaluation of Heat Resistance

Each resin composition prepared as a pellet sample was dried in a hot air dryer at 80° C. for 3 hours and then charged into a molding machine SE-50DU, manufactured by Sumitomo Heavy Industries, Ltd., at a cylinder temperature of 230° C. to form 4-mm-thick dumbbell-shaped test pieces at a mold temperature of 60° C. with a molding cycle of 30 seconds. Three of the obtained dumbbell-shaped test pieces were analyzed according to ISO 75-2 (2004; loading condition: 1.8 MPa) to measure the heat distortion temperature, and the numerical average of the measured values was calculated.

### (11) Evaluation of Morphology

Each resin composition obtained in Example 14 or Comparative Example 7 and prepared as a pellet sample was dried in a hot air dryer at 80° C. for 3 hours and then charged into a molding machine SE-50DU, manufactured by Sumitomo Heavy Industries, Ltd., at a cylinder temperature of 230° C. to form a 4-mm-thick dumbbell-shaped test piece at a mold temperature of 60° C. with a molding cycle of 30 seconds. Each of the obtained dumbbell-shaped test pieces was stained with osmic acid and ruthenium to prepare a sample, and the morphology of the resulting sample was observed at a magnification of 5000 times by using a transmission electron microscope (TEM) HT7700, manufactured by Hitachi High-Tech Co., to evaluate the aggregating properties of each rubber polymer. In this respect, white and black areas in each TEM image indicate an acrylic rubber polymer and a polybutadiene rubber, respectively. Additionally, gray areas indicate the components other than those of the rubber polymer.

### Phosphate Compound (E1) and Polyoxyethylene Alkylamine (E2):

### Phosphate Compound (E1-1)

In a 30-L reactor equipped with a mixing system, 100 parts by mass of Phosphanol RS-610, manufactured by TOHO Chemical Industry Co., Ltd., were placed and heated to 60° C., and 3 parts by mass of calcium hydroxide were added thereto with stirring, and a reaction was allowed to proceed for 30 minutes to obtain a phosphate compound (E1-1). The content of the group II metal atom was 1.6% by mass relative to the obtained phosphate compound (E1-1), which is taken as 100% by mass.

### Phosphate Compound (E1-2)

A phosphate compound (E1-2) was produced in the same manner as the production method for the phosphate compound (E1-1), except that calcium hydroxide was added in an amount of 6 parts by mass. The content of the group II metal atom was 3.2% by mass relative to the obtained phosphate compound (E1-2), which is taken as 100% by mass.

### Polyoxyethylene Alkylamine (E2-1)

SN-WET S, manufactured by San Nopco Ltd., was used.

### Graft Copolymer (A):

### Production Example 1 Graft Copolymer (A-1) Containing the Phosphate Compound (E1-1)

In a 20-m³ reactor equipped with a mixing impeller, 50 parts by mass (solid content) of a polybutadiene latex (volume-average rubber particle size: 0.24 μm), 130 parts by mass of pure water, 0.4 part by mass of sodium laurate, 0.2 part by mass of dextrose, 0.2 part by mass of sodium pyrophosphate, and 0.01 part by mass of ferrous sulfate were placed, and the reactor was purged with nitrogen and then controlled to a temperature of 60° C., and a monomer mixture of 6.7 parts by mass of styrene, 2.5 parts by mass of acrylonitrile, and 0.058 part by mass of t-dodecyl mercaptan was added to the reactor with stirring over 30 minutes.

Subsequently, an initiator mixture of 0.32 part by mass of cumene hydroperoxide, 1.5 parts by mass of sodium laurate emulsifier, and 25 parts by mass of pure water was added dropwise to the reactor over 5 hours. At the same time as this dropwise addition, a dropwise addition of a monomer mixture of 29.8 parts by mass of styrene, 11.0 parts by mass of acrylonitrile, and 0.193 part by mass of t-dodecyl mercaptan to the reactor was started and continued in parallel with the above-mentioned dropwise addition over 3.5 hours. After polymerization was completed, the resulting graft copolymer (A-1) latex was cooled down to 40° C., and 0.5 part by mass of a reaction product of p-cresol, dicyclopentadiene, and isobutylene and 0.2 part by mass of the phosphate compound (E1-1) were added thereto with stirring. Furthermore, the resulting mixture was coagulated with sulfuric acid at a concentration of 1.5% by mass and then neutralized with sodium hydroxide, washed, centrifuged, and dried to obtain a graft copolymer (A-1) containing the phosphate compound (E1-1) (monomer ratio: styrene, 73% by mass; acrylonitrile, 27% by mass). The grafting ratio of the resulting graft copolymer (A-1) was 43%.

### Production Example 2 Graft Copolymer (A-2) Containing the Polyoxyethylene Alkylamine (E2-1)

A graft copolymer (A-2) containing the phosphate compound (E2-1) was produced in the same manner as in Production Example 1, except that the phosphate compound (E1-1) was switched to SN-WET S (E2-1) manufactured by San Nopco Ltd. and the added amount of the SN-WET S (E2-1) was changed to 0.3 part by mass.

### Production Example 3 Graft Copolymer (A-3) Containing the Phosphate Compound (E1-1)

In a 20-m³ reactor equipped with a mixing impeller, 150 parts by mass of pure water and 0.7 part by mass (solid content) of a 25% by mass aqueous solution of disproportionated potassium rosinate emulsifier were placed, and the system was purged with nitrogen gas and then heated to 62° C., and a mixture of 14.9 parts by mass of n-butyl acrylate and 0.1 part by mass of allyl methacrylate was added thereto with stirring over 30 minutes. Subsequently, 0.2 part by mass (solid content) of a 2% by mass aqueous solution of potassium persulfate was continuously added thereto over 285 minutes. In addition, the internal temperature was raised to 65° C. at 105 minutes after starting the addition of the aqueous solution of potassium persulfate, and a mixture of 42.28 parts by mass of n-butyl acrylate and 0.22 part by mass of allyl methacrylate was added thereto over 75 minutes, followed by addition of a mixture of 41.63 parts by mass of n-butyl acrylate and 0.87 part by mass of allyl methacrylate thereto over 75 minutes. Furthermore, 1.3 parts by mass (solid content) of the 25% by mass aqueous solution of disproportionated potassium rosinate were added thereto over 105 minutes at 180 minutes after starting the addition of the aqueous solution of potassium persulfate. After the addition of the aqueous solution of potassium persulfate and the aqueous solution of disproportionated potassium rosinate was completed, the internal temperature was raised to 70° C. and maintained further for 1 hour to obtain an acrylic rubber latex with a polymerization efficiency of 95%.

In the reactor, 50 parts by mass (solid content) of the acrylic rubber latex (volume-average rubber particle size: 0.13 μm), 130 parts by mass of pure water, 0.4 part by mass of sodium laurate, 0.2 part by mass of dextrose, 0.2 part by mass of sodium pyrophosphate, and 0.01 part by mass of ferrous sulfate were placed, and the reactor was purged with nitrogen and then controlled to a temperature of 60° C., and a monomer mixture of 6.7 parts by mass of styrene, 2.5 parts by mass of acrylonitrile, and 0.058 part by mass of t-dodecyl mercaptan was added to the reactor with stirring over 30 minutes.

Subsequently, an initiator mixture of 0.32 part by mass of cumene hydroperoxide, 1.5 parts by mass of sodium laurate emulsifier, and 25 parts by mass of pure water was added dropwise to the reactor over 5 hours. At the same time and in parallel, a monomer mixture of 29.8 parts by mass of styrene, 11.0 parts by mass of acrylonitrile, and 0.193 part by mass of t-dodecyl mercaptan was added dropwise to the reactor over 3.5 hours. After polymerization was completed, the resulting graft copolymer (A-3) latex was cooled down to 40° C., and 0.5 part by mass of a reaction product of p-cresol, dicyclopentadiene, and isobutylene and 0.04 part by mass of the phosphate compound (E1-1) were added thereto with stirring. Furthermore, the resulting mixture was coagulated with sulfuric acid at a concentration of 1.5% by mass and then neutralized with sodium hydroxide, washed, centrifuged, and dried to obtain a graft copolymer (A-3) containing the phosphate compound (E1-1) (monomer ratio: styrene, 73% by mass; acrylonitrile, 27% by mass). The grafting ratio of the resulting graft copolymer (A-3) was 38%.

### Production Example 4 Graft Copolymer (A-4) Containing the Phosphate Compound (E1-1)

A graft copolymer (A-4) containing the phosphate compound (E1-1) was produced in the same manner as in Production Example 3, except that the added amount of the phosphate compound (E1-1) was changed to 0.2 part by mass.

### Production Example 5 Graft Copolymer (A-5) Containing the Phosphate Compound (E1-1)

A graft copolymer (A-5) containing the phosphate compound (E1-1) was produced in the same manner as in Production Example 3, except that the added amount of the phosphate compound (E1-1) was changed to 0.4 part by mass.

### Production Example 6 Graft Copolymer (A-6) Containing the Phosphate Compound (E1-1)

A graft copolymer (A-6) containing the phosphate compound (E1-1) was produced in the same manner as in Production Example 3, except that the added amount of the phosphate compound (E1-1) was changed to 0.6 part by mass.

### Production Example 7 Graft Copolymer (A-7) Containing the Phosphate Compound (E1-2)

A graft copolymer (A-7) containing the phosphate compound (E1-2) was produced in the same manner as in Production Example 3, except that the phosphate compound (E1-2) was used instead of the phosphate compound (E1-1), and that the added amount of the phosphate compound was changed to 0.2 part by mass.

### Production Example 8 Graft Copolymer (A-8) Containing the Polyoxyethylene Alkylamine (E2-1)

A graft copolymer (A-8) containing the polyoxyethylene alkylamine (E2-1) was produced in the same manner as in Production Example 3, except that the phosphate compound (E1-1) was switched to SN-WET S (E2-1) manufactured by San Nopco Ltd. and the added amount of the SN-WET S (E2-1) was changed to 0.06 part by mass.

### Production Example 9 Graft Copolymer (A-9) Containing the Polyoxyethylene Alkylamine (E2-1)

A graft copolymer (A-9) containing the polyoxyethylene alkylamine (E2-1) was produced in the same manner as in Production Example 3, except that SN-WET S (E2-1), manufactured by San Nopco Ltd., was used instead of the phosphate compound (E1-1), and that SN-WET S (E2-1) was added in an amount of 0.3 part by mass.

### Production Example 10 Graft Copolymer (A-10) Containing the Polyoxyethylene Alkylamine (E2-1)

A graft copolymer (A-10) containing the polyoxyethylene alkylamine (E2-1) was produced in the same manner as in Production Example 3, except that SN-WET S (E2-1), manufactured by San Nopco Ltd., was used instead of the phosphate compound (E1-1), and that SN-WET S (E2-1) was added in an amount of 0.6 part by mass.

### Production Example 11 Graft Copolymer (A-11) Containing the Polyoxyethylene Alkylamine (E2-1)

A graft copolymer (A-11) containing the polyoxyethylene alkylamine (E2-1) was produced in the same manner as in Production Example 3, except that SN-WET S (E2-1), manufactured by San Nopco Ltd., was used instead of the phosphate compound (E1-1), and that SN-WET S (E2-1) was added in an amount of 0.9 part by mass.

### Production Example 12 Graft Copolymer (A-12) Containing the Phosphate Compound (E1-1) and the Polyoxyethylene Alkylamine (E2-1)

A graft copolymer (A-12) containing the phosphate compound (E1-1) and the polyoxyethylene alkylamine (E2-1) was produced in the same manner as in Production Example 3, except that the added amount of the phosphate compound (E1-1) was changed to 0.1 part by mass, and that a mixture of the phosphate compound (E1-1) and 0.15 part by mass of SN-WET S (E2-1), manufactured by San Nopco Ltd., was added.

### Production Example 13 Graft Copolymer (A-13)

A graft copolymer (A-13) was produced in the same manner as in Production Example 3, except that the phosphate compound (E1-1) was not added.

### Production Example 14 Graft Copolymer (A-14)

A graft copolymer (A-14) was produced in the same manner as in Production Example 1, except that the phosphate compound (E1-1) was not added.

### Production Example 15 Graft Copolymer (A-15) Containing the Phosphate Compound (E1-1)

A graft copolymer (A-15) containing the phosphate compound (E1-1) was produced in the same manner as in Production Example 1, except that the added amount of the phosphate compound (E1-1) was changed to 0.02 part by mass.

### Production Example 16 Graft Copolymer (A-16) Containing the Polyoxyethylene Alkylamine (E2-1)

A graft copolymer (A-16) containing the polyoxyethylene alkylamine (E2-1) was produced in the same manner as in Production Example 1, except that SN-WET S (E2-1), manufactured by San Nopco Ltd., was used instead of the phosphate compound (E1-1), and that SN-WET S (E2-1) was added in an amount of 0.03 part by mass.

### Production Example 17 Graft Copolymer (A-17) Containing the Phosphate Compound (E1-1)

A graft copolymer (A-17) containing the phosphate compound (E1-1) was produced in the same manner as in Production Example 3, except that the added amount of the phosphate compound (E1-1) was changed to 0.02 part by mass.

### Production Example 18 Graft Copolymer (A-18) Containing the Polyoxyethylene Alkylamine (E2-1)

A graft copolymer (A-18) containing the polyoxyethylene alkylamine (E2-1) was produced in the same manner as in Production Example 3, except that SN-WET S (E2-1), manufactured by San Nopco Ltd., was used instead of the phosphate compound (E1-1), and that SN-WET S (E2-1) was added in an amount of 0.03 part by mass.

### Vinyl Copolymer (B):

### Production Example 19 Vinyl Copolymer (B-1)

A continuous bulk polymerization machine consisting of a 2-m³ complete mixing polymerization vessel equipped with a steam condenser for evaporation and distillation and with a helical ribbon impeller, a single-screw extruder-type preheating machine, and a twin-screw extruder-type monomer removing machine was used to produce a vinyl copolymer (B-1) by the following method.

First, a monomer mixture (b) of 72 parts by mass of styrene, 28 parts by mass of acrylonitrile, 0.2 part by mass of n-octyl mercaptan, and 0.015 part by mass of 1,1-bis(t-butylperoxy)cyclohexane was continuously fed into the complete mixing polymerization vessel at a rate of 150 kg/hour and were continuously bulk polymerized while the polymerization temperature and the pressure inside the vessel were maintained at 130° C. and 0.08 MPa, respectively. The polymerization efficiency of the polymerization reaction mixture at the outlet of the complete mixing polymerization vessel was controlled to be 65±3%.

Next, the polymerization reaction mixture was pre-heated with the single-screw extruder-type preheating machine and then fed into the twin-screw extruder-type monomer removing machine to collect unreacted monomers from a vent of the twin-screw extruder-type monomer removing machine by evaporation under reduced pressure. The collected unreacted monomers were continuously returned to the complete mixing polymerization vessel. Once the apparent polymerization efficiency reached 99% or above, a styrene-acrylonitrile copolymer was fed at a rate of 150 kg/hour and melt mixed. The melt mixture was extruded into strands and cut with a cutter to obtain pellets of a vinyl copolymer (B-1) (monomer ratio: styrene, 72% by mass; acrylonitrile, 28% by mass) with a length of 3 mm. The weight-average molecular weight of the obtained vinyl copolymer (B-1) was 128,000.

### Examples 1 to 13 and Comparative Examples 1 to 6

Amounts of a graft copolymer (A), a vinyl copolymer (B), a phosphate compound (E1), and a polyoxyethylene alkylamine (E2) indicated in Table 1 or 2, 0.8 part by mass of carbon black, 1 part by mass of ethylenebis(stearamide), 0.3 part by mass of bis(2,2,6,6-tetramethyl-4-piperidinyl)sebacate, 0.3 part by mass of 2-(2H-benzotriazol-2-yl)-4-methylphenol, and 0.15 parts by mass of octadecyl-3-(3,5-di-tetrabutyl-4-hydroxyphenyl)propionate were combined, and the resulting mixture was melt mixed (temperature range: 240 to 260° C.) with screws of a twin-screw extruder having screws having a screw diameter of 30 mm and rotating in the same direction to obtain pellets. In Example 13, 0.1 part by mass of the phosphate compound (E1-1) was added when the other components were combined.

TABLE 1

| | | | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|---|---|
| Graft copolymer (A) | | type | A-1 | A-2 | A-3 | A-4 | A-5 | A-6 | A-7 | A-8 | A-9 |
| | | part | 50 | 50 | 50 | 50 | 50 | 50 | 50 | 50 | 50 |
| Vinyl copolymer (B) | | type | B-1 | B-1 | B-1 | B-1 | B-1 | B-1 | B-1 | B-1 | B-1 |
| | | part | 50 | 50 | 50 | 50 | 50 | 50 | 50 | 50 | 50 |
| Amount of added | | type | E1-1 | — | E1-1 | E1-1 | E1-1 | E1-1 | E1-2 | — | — |
| phosphate | | part | 0.1 | 0 | 0.02 | 0.1 | 0.2 | 0.3 | 0.1 | 0 | 0 |
| compound (E1) | | | | | | | | | | | |
| Amount of added | | type | — | E2-1 | — | — | — | — | — | E2-1 | E2-1 |
| polyoxyethylene | | part | 0 | 0.15 | 0 | 0 | 0 | 0 | 0 | 0.03 | 0.15 |
| alkylamine (E2) | | | | | | | | | | | |
| [Amount of added (E1) | | part | 0.2 | 0 | 0.04 | 0.2 | 0.4 | 0.6 | 0.2 | 0 | 0 |
| relative to 100 parts | | by | | | | | | | | | |
| by mass of (A)] | | mass | | | | | | | | | |
| [Amount of added (E2) | | part | 0 | 0.3 | 0 | 0 | 0 | 0 | 0 | 0.06 | 0.3 |
| relative to 100 parts | | by | | | | | | | | | |
| by mass of (A)] | | mass | | | | | | | | | |
| Evaluation of | Amount of | — | A | A | A | A | B | C | A | A | A |
| latex emulsion | coagulum | | | | | | | | | | |
| stability | | | | | | | | | | | |
| Ratio of total amount | | ppm | 300 | 300 | 60 | 300 | 600 | 900 | 300 | 60 | 300 |
| of E1 and E2 to the | | | | | | | | | | | |
| whole resin composition | | | | | | | | | | | |
| Evaluation of | Charpy impact | kJ/m² | 24 | 25 | 10 | 10 | 10 | 10 | 10 | 11 | 10 |
| impact resistance | strength | | | | | | | | | | |
| Evaluation of | Tensile | % | 19 | 20 | 28 | 28 | 28 | 27 | 32 | 30 | 32 |
| tensile elongation | elongation | | | | | | | | | | |
| Evaluation of | Glossiness | % | 85 | 85 | 86 | 86 | 86 | 86 | 87 | 84 | 85 |
| appearance | | | | | | | | | | | |
| Evaluation of | L-value | — | 5 | 5 | 6 | 6 | 6 | 6 | 6 | 6 | 6 |
| color | | | | | | | | | | | |
| Evaluation of | Mold | — | A | A | A | A | B | C | A | A | A |
| volatility | contamination | | | | | | | | | | |

TABLE 2

| | | | | | | | Comp. | Comp. | Comp. | Comp. | Comp. | Comp. |
|---|---|---|---|---|---|---|---|---|---|---|---|---|
| | | | Ex. 10 | Ex. 11 | Ex. 12 | Ex. 13 | Ex. 1 | Ex. 2 | Ex. 3 | Ex. 4 | Ex. 5 | Ex. 6 |
| Graft copolymer (A) | | type | A-10 | A-11 | A-12 | A-13 | A-14 | A-15 | A-16 | A-13 | A-17 | A-18 |
| | | part | 50 | 50 | 50 | 50 | 50 | 50 | 50 | 50 | 50 | 50 |
| Vinyl copolymer (B) | | type | B-1 | B-1 | B-1 | B-1 | B-1 | B-1 | B-1 | B-1 | B-1 | B-1 |
| | | part | 50 | 50 | 50 | 50 | 50 | 50 | 50 | 50 | 50 | 50 |
| Amount of added | | type | — | — | E1-1 | E1-1 | — | E1-1 | — | — | E1-1 | — |
| phosphate | | part | 0 | 0 | 0.05 | 0.1 | 0 | 0.01 | 0 | 0 | 0.01 | 0 |
| compound (E1) | | | | | | | | | | | | |
| Amount of added | | type | E2-1 | E2-1 | E2-1 | — | — | — | E2-1 | — | — | E2-1 |
| polyoxyethylene | | part | 0.3 | 0.45 | 0.08 | 0 | 0 | 0 | 0.015 | 0 | 0 | 0.015 |
| alkylamine (E2) | | | | | | | | | | | | |
| [Amount of added (E1) | | part | 0 | 0 | 0.1 | 0 | 0 | 0.02 | — | — | 0.02 | — |
| relative to 100 parts | | by | | | | | | | | | | |
| by mass of (A)] | | mass | | | | | | | | | | |
| [Amount of added (E2) | | part | 0.6 | 0.9 | 0.15 | 0 | 0 | — | 0.03 | 0 | — | 0.04 |
| relative to 100 parts | | by | | | | | | | | | | |
| by mass of (A)] | | mass | | | | | | | | | | |
| Evaluation of | Amount of | — | A | A | A | A | A | A | A | A | A | A |
| latex emulsion | coagulum | | | | | | | | | | | |
| stability | | | | | | | | | | | | |
| Ratio of total amount | | ppm | 600 | 900 | 300 | 300 | 0 | 30 | 30 | 0 | 30 | 30 |
| of E1 and E2 to the | | | | | | | | | | | | |
| whole resin composition | | | | | | | | | | | | |
| Evaluation of | Charpy impact | kJ/m² | 10 | 11 | 10 | 11 | 26 | 26 | 26 | 12 | 12 | 12 |
| impact resistance | strength | | | | | | | | | | | |
| Evaluation of | Tensile | % | 32 | 30 | 29 | 27 | 18 | 18 | 18 | 23 | 23 | 24 |
| tensile elongation | elongation | | | | | | | | | | | |
| Evaluation of | Glossiness | % | 85 | 84 | 85 | 82 | 80 | 80 | 80 | 78 | 79 | 78 |
| appearance | | | | | | | | | | | | |
| Evaluation of | L-value | — | 6 | 6 | 6 | 6 | 5 | 5 | 5 | 9 | 9 | 9 |
| color | | | | | | | | | | | | |
| Evaluation of | Mold | — | B | C | A | A | A | A | A | A | A | A |
| volatility | contamination | | | | | | | | | | | |

The resin compositions of Examples 1 to 13 exhibited a Charpy impact strength of not less than 10 kJ/m², a tensile elongation of not less than 19%, a gloss of not less than 80%, and an L-value of not more than 6, indicating that the impact resistance and tensile elongation of the resin compositions are high enough to be utilized and that these resin compositions prevent deterioration of appearance and have a good coloration efficiency. Moreover, the resin compositions of Examples 1 to 4 and 7 to 9 and 12, each of which contained either or both of a phosphate compound (E1) and a polyoxyethylene alkylamine (E2) at a total concentration of not less than 60 ppm (mass/mass) and not more than 600 ppm (mass/mass) relative to 100 parts by mass of the total of the whole resin composition and in each of which the total added amount of either or both of the phosphate compound (E1) and the polyoxyethylene alkylamine (E2) was not less than 0.04 parts by mass and not less than 0.4 part by mass relative to 100 parts by mass of the graft copolymer (A), exhibited a further increased gloss of not less than 85% and were capable of preventing significant deterioration of latex stability and also of preventing significant reduction of volatility.

In contrast, the resin compositions of Comparative Examples 1 to 6, each of which contained either or both of a phosphate compound (E1) and a polyoxyethylene alkylamine (E2) at a total concentration of less than 60 ppm (mass/mass) relative to 100 parts by mass of the total of the whole resin composition, had a poor appearance. Moreover, the resin compositions of Comparative Examples 4 to 6 also had a poor coloration efficiency.

### Production Example 20 Graft Copolymer (A-19) Containing the Phosphate Compound (E1-1)

A graft copolymer (A-19) containing the phosphate compound (E1-1) was produced in the same manner as in Production Example 3, except that the added amount of the phosphate compound (E1-1) was changed to 0.1 part by mass.

### Production Example 21 Graft Copolymer (A-20) Containing the Phosphate Compound (E1-1)

A graft copolymer (A-20) containing the phosphate compound (E1-1) was produced in the same manner as in Production Example 3, except that the added amount of the phosphate compound (E1-1) was changed to 0.05 part by mass.

### Production Example 22 Vinyl Copolymer (B-2)

A continuous bulk polymerization machine consisting of a 2-m³ complete mixing polymerization vessel equipped with a steam condenser for evaporation and distillation and with a helical ribbon impeller, a single-screw extruder-type preheating machine, and a twin-screw extruder-type monomer removing machine was used to produce a vinyl copolymer (B-2) by the following method.

First, a monomer mixture (b) of 65 parts by mass of styrene, 35 parts by mass of acrylonitrile, 0.25 part by mass of n-octyl mercaptan, and 0.016 part by mass of 1,1-bis(t-butylperoxy)cyclohexane was continuously fed into the complete mixing polymerization vessel at a rate of 150 kg/hour and were continuously bulk polymerized while the polymerization temperature and the pressure inside the vessel were maintained at 130° C. and 0.08 MPa, respectively. The polymerization efficiency of the polymerization reaction mixture at the outlet of the complete mixing polymerization vessel was controlled to be 65±3%.

Next, the polymerization reaction mixture was pre-heated with the single-screw extruder-type preheating machine and then fed into the twin-screw extruder-type monomer removing machine to collect unreacted monomers from a vent of the twin-screw extruder-type monomer removing machine by evaporation under reduced pressure. The collected unreacted monomers were continuously returned to the complete mixing polymerization vessel. Once the apparent polymerization efficiency reached 99% or above, a styrene-acrylonitrile copolymer was fed at a rate of 150 kg/hour and melt mixed. The melt mixture was extruded into strands and cut with a cutter to obtain pellets of a vinyl copolymer (B-2) (monomer ratio: styrene, 66% by mass; acrylonitrile, 34% by mass) with a length of 3 mm. The weight-average molecular weight of the obtained vinyl copolymer (B-2) was 140,000.

### Production Example 23 Heat-Resistant Vinyl Copolymer (C-1)

In a 30-L autoclave equipped with a mixing system, 65 parts by mass of styrene, 7 parts by mass of maleic anhydride, 0.3 part by mass of 2,4-diphenyl-4-methyl-1-pentene, and 25 parts by mass of methyl ethyl ketone were placed, and the system was purged with nitrogen gas and then heated to 92° C., and a solution of 28 parts by mass of maleic anhydride and 0.18 parts by mass of t-butylperoxy-2-ethylhexanoate dissolved in 100 parts by mass of methyl ethyl ketone was continuously added thereto over 7 hours. After the addition was completed, 0.03 parts by mass of t-butylperoxy-2-ethylhexanoate was added to the mixture, and the resulting mixture was heated to 120° C. and allowed to react for further 1 hour to obtain a polymer solution of a styrene-maleic anhydride copolymer. Then, 32 parts by mass of aniline and 0.6 parts by mass of triethylamine were added to the polymer solution, and the resulting mixture was allowed to react at 140° C. for 7 hours. The polymer solution was fed into a vented screw extruder following the imidation reaction, and volatile components were removed, and pellets of a heat-resistant vinyl copolymer (C-1) (monomer ratio: styrene, 51% by mass; N-phenylmaleimide, 48% by mass; maleic anhydride, 1% by mass) were obtained. The obtained heat-resistant vinyl copolymer (C-1) had a reduced viscosity (ηsp/c) of 0.46 dl/g.

### Examples 14 to 19 and Comparative Examples 7 to 8

Amounts of a graft copolymer (A), a vinyl copolymer (B), a heat-resistant vinyl copolymer (C), a phosphate compound (E1), and a polyoxyethylene alkylamine (E2) indicated in Table 3, 0.9 parts by mass of carbon black, 0.6 parts by mass of ethylenebis(stearamide), 0.3 part by mass of bis(2,2,6,6-tetramethyl-4-piperidinyl)sebacate, and 0.3 part by mass of octadecyl-3-(3,5-di-tetrabutyl-4-hydroxyphenyl)propionate were combined, and the resulting mixture was melt mixed (temperature range: 260 to 290° C.) with screws of a twin-screw extruder having screws having a screw diameter of 30 mm and rotating in the same direction to obtain pellets.

TABLE 3

| | | | | | | | | | Comp. | Comp. |
|---|---|---|---|---|---|---|---|---|---|---|
| | | | Ex. 14 | Ex. 15 | Ex. 16 | Ex. 17 | Ex. 18 | Ex. 19 | Ex. 7 | Ex. 8 |
| Graft copolymer (A) | Graft copolymer (A)-1 | type | A-4 | A-7 | A-10 | A-19 | A-5 | A-6 | A-13 | A-20 |
| | | part | 22 | 22 | 22 | 22 | 22 | 22 | 22 | 22 |
| | Graft copolymer (A)-2 | type | A-14 | A-14 | A-14 | A-3 | A-4 | A-5 | A-14 | A-14 |
| | | part | 14 | 14 | 14 | 14 | 14 | 14 | 14 | 14 |
| Vinyl copolymer (B) | Vinyl copolymer (B)-1 | type | B-1 | B-1 | B-1 | B-1 | B-1 | B-1 | B-1 | B-1 |
| | | part | 17 | 17 | 17 | 17 | 17 | 17 | 17 | 17 |
| | Vinyl copolymer (B)-2 | type | B-2 | B-2 | B-2 | B-2 | B-2 | B-2 | B-2 | B-2 |
| | | part | 25 | 25 | 25 | 25 | 25 | 25 | 25 | 25 |
| Heat-resistant vinyl copolymer (C-1) | | part | 22 | 22 | 22 | 22 | 22 | 22 | 22 | 22 |
| Amount of added phosphate | | type | E1-1 | E1-2 | — | E1-1 | E1-1 | E1-1 | — | E1-1 |
| compound (E1) | | part | 0.04 | 0.04 | 0 | 0.02 | 0.09 | 0.13 | 0 | 0.01 |
| Amount of added polyoxyethylene | | type | — | — | E2-1 | — | — | — | — | — |
| alkylamine (E2) | | part | 0 | 0 | 0.07 | 0 | 0 | 0 | 0 | 0 |
| [Amount of added (E1) relative | | part by | 0.2 | 0.2 | 0 | 0.1 | 0.4 | 0.6 | 0 | 0.05 |
| to 100 parts by mass of (A)-1] | | mass | | | | | | | | |
| [Amount of added (E1) relative | | part by | 0 | 0 | 0 | 0 | 0 | 0 | 0 | 0 |
| to 100 parts by mass of (A)-2] | | mass | | | | | | | | |
| [Amount of added (E2) relative | | part by | 0 | 0 | 0.3 | 0 | 0 | 0 | 0 | 0 |
| to 100 parts by mass of (A)-2] | | mass | | | | | | | | |
| [Amount of added (E2) relative | | part by | 0 | 0 | 0 | 0 | 0 | 0 | 0 | 0 |
| to 100 parts by mass of (A)-1] | | mass | | | | | | | | |
| Evaluation of latex | Amount of coagulum | — | A | A | A | A | B | C | A | A |
| emulsion stability | | | | | | | | | | |
| Ratio of total amount of E1 and E2 | | ppm | 130 | 130 | 130 | 70 | 260 | 400 | 0 | 30 |
| to the whole resin composition | | | | | | | | | | |
| Evaluation of impact | Charpy impact | kJ/m² | 7 | 7 | 7 | 7 | 7 | 7 | 7 | 7 |
| resistance | strength | | | | | | | | | |
| Evaluation of tensile | Tensile | % | 20 | 25 | 20 | 19 | 22 | 22 | 12 | 14 |
| elongation | elongation | | | | | | | | | |
| Evaluation of | Glossiness | % | 90 | 91 | 89 | 88 | 90 | 90 | 70 | 71 |
| appearance | | | | | | | | | | |
| Evaluation of color | L-value | — | 6 | 6 | 6 | 7 | 6 | 6 | 9 | 8 |
| Evaluation of | Mold | — | A | A | A | A | B | C | A | A |
| volatility | contamination | | | | | | | | | |
| Evaluation of heat | Heat distortion | ° C. | 97 | 97 | 97 | 97 | 97 | 97 | 97 | 97 |
| resistance | temperature | | | | | | | | | |

The resin compositions of Examples 14 to 19 exhibited a Charpy impact strength of not less than 6 kJ/m², a tensile elongation of not less than 19%, a gloss of not less than 88%, an L-value of not more than 7, and a heat distortion temperature of not lower than 96° C., indicating that the impact resistance and tensile elongation of the resin compositions are high enough to be utilized and that these resin compositions prevent deterioration of appearance and have a good coloration efficiency and are further provided with heat resistance. Moreover, the resin compositions of Examples 14 to 17, each of which contained either or both of a phosphate compound (E1) and a polyoxyethylene alkylamine (E2) at a total concentration of not less than 60 ppm (mass/mass) and not more than 600 ppm (mass/mass) relative to 100 parts by mass of the total of the whole resin composition and in each of which the total added amount of either or both of the phosphate compound (E1) and the polyoxyethylene alkylamine (E2) was not less than 0.04 parts by mass and less than 0.4 part by mass relative to 100 parts by mass of the graft copolymer (A), were capable of preventing significant deterioration of latex stability and also of preventing significant reduction of volatility.

In contrast, the resin compositions of Comparative Examples 7 and 8, each of which contained either or both of a phosphate compound (E1) and a polyoxyethylene alkylamine (E2) at a total concentration of less than 60 ppm (mass/mass) relative to 100 parts by mass of the total of the whole resin composition, exhibited insufficient tensile elongation and also had a poor appearance and a poor coloration efficiency.

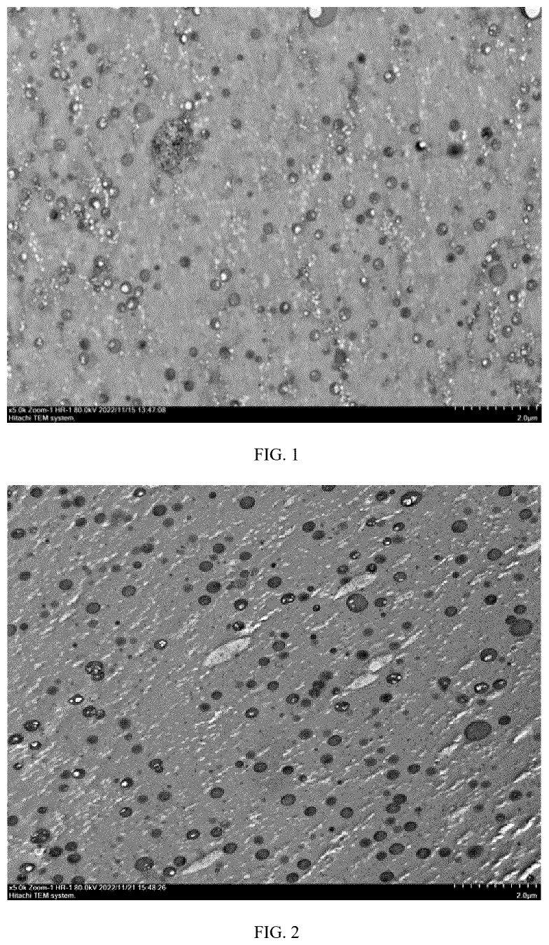

In addition, when the morphologies of the resin compositions were observed, it was found that white areas, each of which indicates an acrylic rubber polymer, are finely dispersed in Example 14, as shown in FIG. 1; in Comparative Example 7, white areas, each of which indicates an acrylic rubber polymer, are merged into larger areas than the white areas shown in FIG. 1, as shown in FIG. 2, suggesting aggregation of rubbers.

### INDUSTRIAL APPLICABILITY

Our resin compositions and molded articles therefrom can be widely used in application fields of home electric appliances, daily necessities, automobile components, and the like.

What is claimed is:

1. A resin composition comprising a graft copolymer (A) obtained by graft copolymerization of a monomer mixture (a) comprising at least an aromatic vinyl monomer (a1) and a vinyl cyanide monomer (a2) in the presence of a rubber polymer (r); a vinyl copolymer (B) obtained by copolymerization of a monomer mixture (b) comprising at least an aromatic vinyl monomer (b1) and a vinyl cyanide monomer (b2); and either or both of a phosphate compound (E1) represented by chemical formula (1) and a polyoxyethylene alkylamine (E2) represented by chemical formula (2), wherein a ratio of a total amount of the phosphate compound (E1) and the polyoxyethylene alkylamine (E2) to the whole resin composition is not less than 60 ppm (mass/mass): 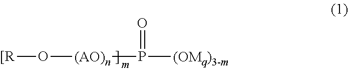
wherein R represents an alkyl or alkenyl group containing 8 to 22 carbon atoms; AO represents an oxyalkylene group containing 2 or 3 carbon atoms; n is an integer of 1 to 20; m is an integer of 1 or 2; M represents a hydrogen atom, a group I metal atom, or a group II metal atom; and q is 1 in cases where M is a hydrogen atom or a group I metal atom, or q is ½ in cases where M is a group II metal atom; 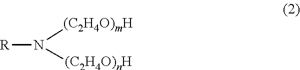
wherein R represents an alkyl or alkenyl group containing 8 to 22 carbon atoms; and m and n are positive integers that satisfy the formula: 2<m+n≤20.

2. The resin composition according to claim 1, wherein the rubber polymer (r) is either or both of a polybutadiene rubber and an acrylic rubber.

3. The resin composition according to claim 1, further comprising a heat-resistant vinyl copolymer (C) obtained by copolymerization of a vinyl monomer mixture (c) comprising at least an aromatic vinyl monomer (c1) and a maleimide monomer (c2).

4. A method of producing a resin composition, the method comprising:
(A) producing an emulsion polymer latex obtained by graft copolymerization of a monomer mixture (a) comprising at least an aromatic vinyl monomer (a1) and a vinyl cyanide monomer (a2) in the presence of a rubber polymer (r), and adding either or both of a phosphate compound (E1) and a polyoxyethylene alkylamine (E2) to the emulsion polymer latex, and later allowing the emulsion polymer latex to contact aqueous sulfuric acid solution to produce a graft copolymer (A),
(B) producing a vinyl copolymer (B) obtained by copolymerization of a monomer mixture (b) comprising at least an aromatic vinyl monomer (b1) and a vinyl cyanide monomer (b2), and
mixing the graft copolymer (A) and vinyl copolymer (B) obtained in steps (A) and (B),
wherein a ratio of a total amount of the phosphate compound (E1) and the polyoxyethylene alkylamine (E2) to the whole resin composition is adjusted to be not less than 60 ppm (mass/mass).

5. The method of producing a resin composition according to claim 4, wherein the phosphate compound (E1) is used in step (A), wherein a content of a group II metal atom in the phosphate compound (E1) is not less than 2% by mass and not more than 5% by mass, where the mass of the phosphate compound (E1) is taken as 100% by mass.

6. A molded article obtained by molding the resin composition according to claim 1.

7. A molded article obtained by molding a resin composition obtained by the method of producing a resin composition according to claim 4.

8. The method of producing a resin composition according to claim 4, further comprising:
(C) producing a heat-resistant vinyl copolymer (C) obtained by copolymerization of a vinyl monomer mixture (c) comprising at least an aromatic vinyl monomer (c1) and a maleimide monomer (c2), and
wherein the mixing of the graft copolymer (A) and vinyl copolymer (B) further includes mixing with the heat-resistant vinyl copolymer (C).
